(19) United States
(12) Patent Application Publication
(10) Pub. No.: US 2013/0103378 A1
(43) Pub. Date: Apr. 25, 2013

(54) ELECTRICITY DEMAND PREDICTION

(71) Applicants: Peerapol Tinnakornsrisuphap, San Diego, CA (US); Lukas D. Kuhn, San Diego, CA (US); Tao Chen, La Jolla, CA (US)

(72) Inventors: Peerapol Tinnakornsrisuphap, San Diego, CA (US); Lukas D. Kuhn, San Diego, CA (US); Tao Chen, La Jolla, CA (US)

(73) Assignee: QUALCOMM Incorporated, San Diego, CA (US)

(21) Appl. No.: 13/445,661

(22) Filed: Apr. 12, 2012

Related U.S. Application Data
(60) Provisional application No. 61/483,520, filed on May 6, 2011.

(51) Int. Cl. G06F 17/50

(52) U.S. Cl. CPC G06F 17/5009
USPC 703/18

(57) ABSTRACT

Various arrangements for anticipating an electrical load are presented. A plurality of indications of locations of a vehicle may be received. A travel pattern of the vehicle based on the plurality of indications of locations of the vehicle may be determined. The travel pattern may indicate a destination and an expected travel time to arrive at the destination. A current location of the vehicle may be received. At least partially based on the current location of the vehicle, whether the vehicle is expected to conform to the travel pattern may be determined. An anticipated electrical load at the destination may be determined at least partially based on the travel pattern.

### CROSS REFERENCES

This Application claims priority to U.S. Provisional Patent Application No. 61/483,520, filed May 6, 2011, entitled Electricity Demand Prediction, Attorney Docket Number 111644P1. This Provisional Application is incorporated in its entirety for all purposes.

### BACKGROUND

Demand for electricity tends to vary throughout the day. If demand for electricity increases (e.g., an increased amount of load on an electrical grid), additional sources of electricity may need to start producing electricity in order to meet the demand. Further, electricity production tends to be inflexible. More efficient (e.g., cost effective, environmentally friendly) sources of electricity tend to be sources that take a substantial period of time to bring online. Therefore, in order to meet a spike in demand, less efficient sources of electricity are used to meet production needs. For example, diesel generators can be brought online in a matter of minutes, but are expensive to operate per megawatt of production compared to, for example, natural gas plants, which tend to be less expensive to operate per megawatt of production but may take approximately 30 minutes to two hours to bring online. As such, if demand for electricity can be accurately predicted, more efficient electricity generation sources can be used by bringing them online in anticipation of an increase in demand. Further, if demand for electricity can be decreased at certain times, such as when a spike in demand occurs, it may be possible to eliminate the need to bring additional power sources online and/or decrease the stress on an electrical distribution system.

### SUMMARY

Various arrangements for anticipating an electrical load are presented. In some embodiments, a method for anticipating an electrical load is presented. The method may include receiving, by a computer system, a plurality of indications of locations of a vehicle. The method may include identifying, by the computer system, a travel pattern of the vehicle based on the plurality of indications of locations of the vehicle. The travel pattern may indicates a destination and an expected travel time to arrive at the destination. The method may include receiving, by the computer system, a current location of the vehicle. The method may include identifying, by the computer system, an anticipated electrical load at the destination at least partially based on the travel pattern.

Embodiments of such a method may include one or more of the following: The method may include identifying a decrease in anticipated electrical load at the current location of the vehicle at least partially based on the vehicle departing from the current location. The method may include at least partially based on the current location of the vehicle, determining, by the computer system, that the vehicle is expected to conform to the travel pattern. The method may include modifying, by the computer system, electrical usage at least partially based on an anticipated arrival of the vehicle at the destination. Modifying electrical usage at least partially based on the anticipated arrival of the vehicle at the destination may be further at least partially based on the expected travel time to arrive at the destination indicated by the travel pattern. The vehicle may be a chargeable electric vehicle. Modifying electrical usage at least partially based on the anticipated arrival of the vehicle at the destination may comprise allocating sufficient electrical capacity to at least partially charge the chargeable electric vehicle. The method may include determining an identity of a person associated with the travel pattern, wherein modifying electrical usage at least partially based on the anticipated arrival of the vehicle at the destination is at least partially based on the identity of the person. Modifying electrical usage at least partially based on the anticipated arrival of the vehicle at the destination may comprise activating an electrical device before the anticipated arrival of the vehicle at the destination. Modifying electrical usage at least partially based on the anticipated arrival of the vehicle at the destination may comprise modifying a charging schedule of a second vehicle. The charging schedule may comprise a rate of charging. Charging of the second vehicle may occur at a location different from the destination. The plurality of indications of locations may be determined by a mobile device and the current location of the vehicle may be based on the mobile device's location. Modifying electrical usage at least partially based on the anticipated arrival of the vehicle at the destination may comprise indicating that a power-generation source is to be activated.

In some embodiments, a method for scheduling charging of an electric vehicle is presented. The method may include identifying, by a computer system, a charging budget. The method may include receiving, by the computer system, a pricing rate for electricity. The method may include determining, by the computer system, to charge the electric vehicle at the pricing rate using the charging budget. Also, the method may include transmitting, by the computer system, an indication to charge the electric vehicle to a remote computer system.

Embodiments of such a method may include one or more of the following: The method may include identifying, by the computer system, a current level of charge of the electric vehicle. The method may include identifying, by the computer system, an anticipated destination. The method may include identifying, by the computer system, an anticipated time of departure. The method may include determining, by the computer system, the charging budget using the anticipated destination, the current level of charge of the electric vehicle, and the anticipated destination. The method may include receiving, by the computer system, a budget parameter from a user of the electric vehicle, wherein the charging budget is created using the budget parameter.

In some embodiments, a system for anticipating an electrical load is presented. The system may include a processor. The system may include a memory communicatively coupled with and readable by the processor and having stored therein processor-readable instructions. When executed by the processor, the processor-readable instructions may cause the processor to receive a plurality of indications of locations of a vehicle. When executed by the processor, the processor-readable instructions may cause the processor to identify a travel pattern of the vehicle based on the plurality of indications of locations of the vehicle. The travel pattern may indicate a destination and an expected travel time to arrive at the destination. When executed by the processor, the processor-readable instructions may cause the processor to receive a current location of the vehicle. When executed by the processor, the processor-readable instructions may cause the processor to identify an anticipated electrical load at the destination at least partially based on the travel pattern.

Such a system may further include one or more of the following: The processor-readable instructions may be configured to, when executed, cause the processor to identify a decrease in anticipated electrical load at the current location of the vehicle at least partially based on the vehicle departing from the current location. When executed by the processor, the processor-readable instructions may cause the processor to, at least partially based on the current location of the vehicle, determine that the vehicle is expected to conform to the travel pattern. When executed by the processor, the processor-readable instructions may cause the processor to cause electrical usage to be modified at least partially based on an anticipated arrival of the vehicle at the destination. The processor-readable instructions, which, when executed by the processor cause the processor to cause electrical usage to be modified at least partially based on the anticipated arrival of the vehicle at the destination may be further at least partially based on the expected travel time to arrive at the destination indicated by the travel pattern. The vehicle may be a chargeable electric vehicle. The processor-readable instructions, which, when executed by the processor cause the processor to cause electrical usage to be modified at least partially based on the anticipated arrival of the vehicle at the destination may further comprise processor-readable instructions, which, when executed by the processor, cause the processor to allocate sufficient electrical capacity to at least partially charge the chargeable electric vehicle. The processor-readable instructions may further comprise processor-readable instructions, which, when executed by the processor, cause the processor to determine an identity of a person associated with the travel pattern, wherein the processor-readable instructions, which, when executed by the processor, cause the processor to cause electrical usage to be modified at least partially based on the anticipated arrival of the vehicle at the destination is at least partially based on the identity of the person. The processor-readable instructions, which, when executed by the processor, cause the processor to cause electrical usage to be modified at least partially based on the anticipated arrival of the vehicle at the destination may further comprise processor-readable instructions, which, when executed by the processor, cause the processor to cause an electrical device to be activated before the anticipated arrival of the vehicle at the destination.

Further, such a system may additionally or alternatively include one or more of the following: The processor-readable instructions, which, when executed by the processor, cause the processor to cause electrical usage to be modified at least partially based on the anticipated arrival of the vehicle at the destination may comprise processor-readable instructions, which, when executed by the processor, cause the processor to modify a charging schedule of a second vehicle. The charging schedule may comprise a rate of charging. Charging of the second vehicle may occur at a location different from the destination. The plurality of indications of locations may be determined by a mobile device. The current location of the vehicle may be based on the mobile device's location. The processor-readable instructions, which, when executed by the processor, cause the processor to cause electrical usage to be modified at least partially based on the anticipated arrival of the vehicle at the destination may comprise processor-readable instructions, which, when executed by the processor, cause the processor to indicate that a power-generation source is to be activated.

In some embodiments, a system for scheduling charging an electric vehicle may be presented. The system may include a processor. The system may also include a memory communicatively coupled with and readable by the processor and having stored therein processor-readable instructions. When executed by the processor, the processor-readable instructions may cause the processor to identify a charging budget. When executed by the processor, the processor-readable instructions may cause the processor to receive a pricing rate for electricity. When executed by the processor, the processor-readable instructions may cause the processor to, using the charging budget, determine to charge the electric vehicle at the pricing rate. When executed by the processor, the processor-readable instructions may cause the processor to cause an indication to charge the electric vehicle to be transmitted to a remote computer system.

Such a system may include one or more of the following: The processor-readable instructions may further comprise processor-readable instructions, which, when executed by the processor, cause the processor to identify a current level of charge of the electric vehicle. When executed by the processor, the processor-readable instructions may also cause the processor to identify an anticipated destination. When executed by the processor, the processor-readable instructions may cause the processor to identify an anticipated time of departure. When executed by the processor, the processor-readable instructions may cause the processor to determine the charging budget using the anticipated destination, the current level of charge of the electric vehicle, and the anticipated destination. The processor-readable instructions may further comprise processor-readable instructions, which, when executed by the processor, cause the processor to receive a budget parameter from a user of the electric vehicle, wherein the charging budget is created using the budget parameter.

In some embodiments, a computer program product residing on a non-transitory processor-readable medium for anticipating an electrical load may be presented. The computer program product may comprise processor-readable instructions configured to cause a processor to receive a plurality of indications of locations of a vehicle. The processor-readable instructions, when executed, may be configured to cause the processor to identify a travel pattern of the vehicle based on the plurality of indications of locations of the vehicle. The travel pattern may indicate a destination and an expected travel time to arrive at the destination. The processor-readable instructions, when executed, may be configured to cause the processor to receive a current location of the vehicle. The processor-readable instructions, when executed, may be configured to cause the processor to identify an anticipated electrical load at the destination at least partially based on the travel pattern.

Embodiments of such a computer program product may include one or more of the following: The processor-readable instructions may be configured to, when executed, cause the processor to identify a decrease in anticipated electrical load at the current location of the vehicle at least partially based on the vehicle departing from the current location. The processor-readable instructions may further comprise processor-readable instructions, which, when executed by the processor, cause the processor to at least partially based on the current location of the vehicle, determine that the vehicle is expected to conform to the travel pattern. The processor-readable instructions may further comprise processor-readable instructions, which, when executed by the processor, cause the processor to cause electrical usage to be modified at least partially based on an anticipated arrival of the vehicle at the destination. The processor-readable instructions, which, when executed by the processor cause the processor to cause electrical usage to be modified at least partially based on the anticipated arrival of the vehicle at the destination may further be at least partially based on the expected travel time to arrive at the destination indicated by the travel pattern. The processor-readable instructions, which, when executed by the processor, cause the processor to cause electrical usage to be modified at least partially based on the anticipated arrival of the vehicle at the destination may further comprise processor-readable instructions, which, when executed by the processor, cause the processor to cause an electrical device to be activated before the anticipated arrival of the vehicle at the destination. The vehicle may be a chargeable electric vehicle. The processor-readable instructions, which, when executed by the processor cause the processor to cause electrical usage to be modified at least partially based on the anticipated arrival of the vehicle at the destination may comprise processor-readable instructions, which, when executed by the processor, cause the processor to allocate sufficient electrical capacity to at least partially charge the chargeable electric vehicle.

Embodiments of such a computer program product may additionally or alternatively include one or more of the following: The processor-readable instructions may further comprise processor-readable instructions, which, when executed by the processor, cause the processor to determine an identity of a person associated with the travel pattern, wherein the processor-readable instructions, which, when executed by the processor, cause the processor to cause electrical usage to be modified at least partially based on the anticipated arrival of the vehicle at the destination is at least partially based on the identity of the person. The processor-readable instructions, which, when executed by the processor, cause the processor to cause electrical usage to be modified at least partially based on the anticipated arrival of the vehicle at the destination may comprise processor-readable instructions, which, when executed by the processor, cause the processor to modify a charging schedule of a second vehicle. Charging of the second vehicle may occur at a location different from the destination. The plurality of indications of locations may be determined by a mobile device. The current location of the vehicle may be based on the mobile device's location. The processor-readable instructions, which, when executed by the processor, cause the processor to cause electrical usage to be modified at least partially based on the anticipated arrival of the vehicle at the destination comprises processor-readable instructions, which, when executed by the processor, may cause the processor to indicate that a power-generation source is to be activated.

In some embodiments, a computer program product residing on a non-transitory processor-readable medium for scheduling charging of an electric vehicle may be presented. The computer program product may comprise processor-readable instructions configured to cause a processor to identify a charging budget. The processor-readable instructions, when executed, may further be configured to cause the processor to receive a pricing rate for electricity. The processor-readable instructions, when executed, may further be configured to cause the processor to, using the charging budget, determine to charge the electric vehicle at the pricing rate. The processor-readable instructions, when executed, may further be configured to cause the processor to cause an indication to charge the electric vehicle to be transmitted to a remote computer system.

Embodiments of such a computer program product may include one or more of the following: The processor-readable instructions may further comprise processor-readable instructions, which, when executed by the processor, cause the processor to identify a current level of charge of the electric vehicle. The processor-readable instructions, when executed, may further be configured to cause the processor identify an anticipated destination. The processor-readable instructions, when executed, may further be configured to cause the processor identify an anticipated time of departure. The processor-readable instructions, when executed, may further be configured to cause the processor determine the charging budget using the anticipated destination, the current level of charge of the electric vehicle, and the anticipated destination. The processor-readable instructions may further comprise processor-readable instructions, which, when executed by the processor, cause the processor to receive a budget parameter from a user of the electric vehicle, wherein the charging budget is created using the budget parameter.

In some embodiments, an apparatus for anticipating an electrical load is presented. The apparatus may include means for receiving a plurality of indications of locations of a vehicle. The apparatus may include means for identifying a travel pattern of the vehicle based on the plurality of indications of locations of the vehicle. The travel pattern may indicate a destination and an expected travel time to arrive at the destination. The apparatus may include means for receiving a current location of the vehicle. The apparatus may include means for identifying an anticipated electrical load at the destination at least partially based on the travel pattern.

Embodiments of such an apparatus may include one or more of the following: The apparatus may further include means to identify a decrease in anticipated electrical load at the current location of the vehicle at least partially based on the vehicle departing from the current location. The apparatus may further include means for determining that the vehicle is expected to conform to the travel pattern at least partially based on the current location of the vehicle. The apparatus may further include means for modifying electrical usage at least partially based on an anticipated arrival of the vehicle at the destination. The means for modifying electrical usage at least partially based on the anticipated arrival of the vehicle at the destination may further be at least partially based on the expected travel time to arrive at the destination indicated by the travel pattern. The vehicle may be a chargeable electric vehicle. The means for modifying electrical usage at least partially based on the anticipated arrival of the vehicle at the destination may further comprise means for allocating sufficient electrical capacity to at least partially charge the chargeable electric vehicle. The means for modifying electrical usage at least partially based on the anticipated arrival of the vehicle at the destination may comprise means for activating an electrical device before the anticipated arrival of the vehicle at the destination. The apparatus may further include means for determining an identity of a person associated with the travel pattern, wherein modifying electrical usage at least partially based on the anticipated arrival of the vehicle at the destination is at least partially based on the identity of the person. The means for modifying electrical usage at least partially based on the anticipated arrival of the vehicle at the destination may comprise means for modifying a charging schedule of a second vehicle. The charging schedule may comprise a rate of charging. Charging of the second vehicle may occur at a location different from the destination. The plurality of indications of locations may be determined by a mobile device. The current location of the vehicle may be based on the mobile device's location. The means for modifying electrical usage at least partially based on the anticipated arrival of the vehicle at the destination may comprise means for indicating that a power-generation source is to be activated.

In some embodiments, an apparatus for scheduling charging of an electric vehicle is presented. The apparatus may include means for identifying a charging budget. The apparatus may include means for receiving a pricing rate for electricity. The apparatus may include means for determining to charge the electric vehicle at the pricing rate using the charging budget. The apparatus may include means for transmitting an indication to charge the electric vehicle to a remote computer system.

Embodiments of such an apparatus may include one or more of the following: The apparatus may include means for identifying a current level of charge of the electric vehicle. The apparatus may include means for identifying an anticipated destination. The apparatus may include means for identifying an anticipated time of departure. The apparatus may include means for determining the charging budget using the anticipated destination, the current level of charge of the electric vehicle, and the anticipated destination. The apparatus may include means for receiving a budget parameter from a user of the electric vehicle, wherein the charging budget is created using the budget parameter.

In some embodiments, a method for anticipating a decrease in an electrical load is presented. The method may include receiving, by the computer system, a current location of the vehicle. The method may include determining, by the computer system, the vehicle is departing from the current location. Further, the method may include identifying, by the computer system, an anticipated decrease in electrical load at the current location at least partially based on the vehicle departing.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a block diagram of an embodiment of a system for electricity demand prediction.

FIG. 2 illustrates a block diagram of another embodiment of a system for electricity demand prediction.

FIG. 3 illustrates a block diagram of another embodiment of a system for electricity demand prediction.

FIG. 4 illustrates an embodiment of charts comparing a departure time from an origination location with the probability of being at a destination following departure.

FIG. 5 illustrates an embodiment of a method for electricity demand prediction.

FIG. 6 illustrates an embodiment of a method for electricity demand prediction and modifying electricity usage.

FIG. 7 illustrates an embodiment of a method for modifying electricity usage.

FIG. 8 illustrates an embodiment of a method for electricity demand prediction and modifying electricity usage based on an appliance initiation sequence.

FIG. 9 illustrates an embodiment of a method for notifying an ESI (Electrical Service Interface) of vehicle charging information.

FIG. 10 illustrates a swim diagram of an embodiment of a method for managing the charging of an electric vehicle.

FIG. 11 illustrates a swim diagram of another embodiment of a method for managing the charging of an electric vehicle.

FIG. 12 illustrates a swim diagram of another embodiment of a method for managing the charging of an electric vehicle.

FIG. 13 illustrates a swim diagram of an embodiment of a method for managing the charging of an electric vehicle in accordance with one or more local constraints.

FIG. 14 illustrates an embodiment of a computer system.

### DETAILED DESCRIPTION

According to various embodiments of the invention, network-enabled devices can be used to predict demand for electricity and/or decrease (peak) consumption levels of electricity.

Electricity use at a location may tend to increase when one or more persons are present. For example, residential homes tend to consume less electricity when residents are away (e.g., at work) and consume more electricity when residents are home. At one or more times during a typical day, electrical use may spike in a geographic region. For example, in the afternoon of a summer's day, people may turn on air conditioners when they return home from work. Such use may result in a spike in the demand for electricity.

As the amount of time necessary for an electricity generation source to come online and generate electricity decreases, the cost to generate such electricity tends to increase. Electricity generation sources, such as diesel generators, can be expensive to operate, but can be ready to generate electricity in a short period of time, such as a few minutes. Other electricity generation sources, such as natural gas plants, tend to cost less to operate (per megawatt of generation), but may take a longer period of time to come online, such as approximately 30 minutes to two hours. Other electricity generation sources, such as nuclear and coal power plants, may cost even less to operate (per megawatt of production), but are typically continuously operating. As such, by decreasing the amount of time that inefficient sources, such as diesel generators, are operating, and increasing the time other electricity generation sources are productively being used, efficiency may be increased.

By predicting when electrical usage is expected to increase, more efficient power generation sources may be brought online ahead of the demand. To further increase efficiency, affirmative steps may be taken to decrease the demand of electricity, especially at times of peak consumption. For example, this may involve modifying when various electrical devices (e.g., electric vehicles, appliances) are provided electricity.

According to a first group of embodiments of the invention, based on information such as a person's typical travel patterns (e.g., commute home from work) as measured by a mobile device (e.g., a cellular phone) or a vehicle, it can be estimated by how much and when electrical usage at the person's residence will increase. This lead time signaled by the person's travel patterns, along with the lead time signaled by other residents, can be used for predictive modeling of electricity consumption and can be used to identify when electricity generation sources should be brought online in anticipation of increased demand and/or whether steps should be taken to reduce the anticipated demand. Further, modeling of the electricity consumption of neighborhoods and/or grid-wide demand can be modeled based on a sample of the population because residents within a neighborhood tend to have similar travel patterns (e.g., parents tend to pick up children from school at the same time).

In a second group of embodiments of the invention, a person's travel patterns can be used to stagger electrical demand such that the peak demand of electricity across an electrical grid is decreased. For example, if many residents of an area typically turn on air conditioning when they arrive home, electricity demand may spike following the evening rush hour. A resident's travel patterns may be used to decrease peak demand by staggering when one or more electrical devices, such as air conditioners, are turned on. As such, before a resident arrives home, an air conditioner (or some other electrical device) may be turned on for a period of time (e.g., turned on earlier than is typical), then turned off and another resident's air conditioner turned on (thus preventing two air conditioners from being on at the same time). One or more air conditioners may be preemptively activated in order to decrease demand when the residents arrive home. Each resident's travel patterns may be used to optimize when each air conditioner is turned on such that both residents arrive at their respective residences to a cooled environment. Similar principles can be applied to other electrical devices based on the person's travel patterns to other locations.

In a third group of embodiments of the invention, “smart” appliances and/or electrical outlets (collectively referred to as “smart devices”) are network-enabled and may report when they are under electrical load and/or their electricity usage. Information gathered from these smart devices may be used for predictive modeling as to when other smart devices may be activated. For example, if a washing machine is turned on, based on this information, it may be predicted that an hour later a dryer may be turned on. Similarly, sequences of power use by smart devices may be determined. As another example, when a resident opens a garage door around a certain time of day (e.g., the resident is arriving home from work at 5 PM), this may signal the beginning of a sequence of electrical usage, such as a stove being turned on, lights being turned on, the air conditioning being turned on, and a refrigerator consuming more power (e.g., the door being opened and shut requiring more cooling). Further, different persons (e.g., as determined by location of their cellular phones) being at the same residence may indicate different electrical usage patterns. Such sequences of power consumption, as identified from data received from smart devices or outlets that may be able to communicate usage information, may be used for predictive modeling of the power consumption at a particular location and/or an electrical grid.

In a fourth group of embodiments of the invention, an appropriate time for the charging of an electric vehicle can be determined based on the vehicle's typical travel pattern and behavior. For example, if a resident typically leaves his residence at 10 AM, charging of his electrical car may be delayed in favor of some other resident who typically leaves his residence at 7 AM (or some other use of electricity). As such, a vehicle's charging pattern can be based on the vehicle's travel pattern and actual charging history. A vehicle's current level of charge in conjunction with the vehicle's typical travel patterns may be used to determine how much and how fast the vehicle should be recharged. If a vehicle's travel pattern indicates that the vehicle is likely to need to be driven shortly in the future and the vehicle's batteries are depleted, this vehicle may be given priority to charge sooner and quicker. Further, if a lot of vehicles are determined to be destined for the same area (e.g., such as electric vehicles used by a group of people to commute to the same downtown area) and are each likely going to need to be recharged, this information can be used to anticipate an upcoming increased electrical load on the electrical grid, e.g., preparing for load reduction on the nearby area so that the grid distribution would be able to handle the required power output. In addition to the vehicle's travel pattern, the electric grid's record of a vehicle's charging day and/or time, location, duration, amount, and/or the absolute battery charge levels from plugging in to unplugging can be used with the travel pattern (or alone) to determine the optimal way the vehicle should be recharged next time it is plugged in.

In a fifth group of embodiments of the invention, various arrangements are presented for determining if, when, and/or at what rate an electric vehicle should be charged. Various factors may be evaluated to determine if, when, and/or at what rate the electric vehicle should be charged. In some embodiments, a vehicle operator may specify a budget. Such a budget may identify an amount (per electrical unit) that the operator is willing to pay. This budget may be used in conjunction with variables such as: the vehicle's current level of charge, the expected departure time of the vehicle from the charging location, the cost to charge, and the expected charge needed to travel to the expected destination. Based on such factors, a determination may occur at the electric vehicle, a mobile device, host computer system, or an electrical service interface as to whether the vehicle should be charged, when it should charged, and/or at what rate charging should occur. In some embodiments, vehicles for charging may be selected on an auction basis.

As such, a computerized system that receives location, power consumption, and usage pattern information from various network-enabled devices (cellular phones, fleet management equipment, home networks, smart meters, smart devices, etc.) may be used to predict electricity consumption, signal when additional electrical generation sources should be brought online, and/or determine how an electrical load should be spread across a grid to decrease peak power consumption.

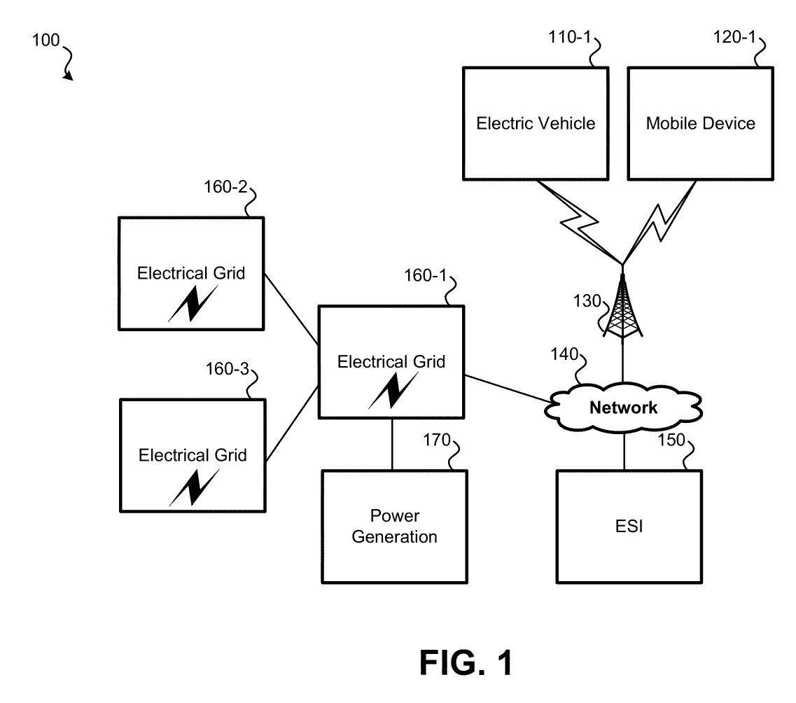

FIG. 1 illustrates a block diagram of an embodiment of a system 100 for electricity demand prediction. System 100 includes: electric vehicle 110-1, mobile device 120-1, wireless network 130, network 140, electrical service interface (ESI) 150, electrical grid 160, and power generation 170.

Electric vehicle 110-1 may represent an electric vehicle that requires electrical charging by an external source. Electric vehicle 110-1 may have a subsystem that is capable of communicating via one or more wireless networks with ESI 150 (and/or some other computer system). Electric vehicle 110-1 may capture location information that indicates where electric vehicle 110-1 is located, such as GPS data. Electric vehicle 110-1 may be able to communicate using cellular wireless networks. Electric vehicle 110-1 may also be able to communicate using other types of wireless networks, such as WiFi networks. Electric vehicle 110-1 may also be able to communicate via a wireline network, such as powerline communication (PLC). As such, electric vehicle 110-1 may communicate via an EVSE (Electric Vehicle Supply Equipment) using powerline based communication. An EVSE may be used to charge one or more electric vehicles. Communication with a wireline network may occur via the EVSE. In some embodiments, electric vehicle 110-1 may communicate with ESI 150 via a cellular network when electric vehicle 110-1 is out of range of a WiFi network (e.g., during driving); a WiFi network may be used when the vehicle has WiFi service (e.g., when parked within a garage of the driver's residence). Electric vehicle 110-1 may transmit data to ESI 150 such as: a current charge level of electric vehicle 110-1's batteries, an expected destination, a current location, and an expected arrival time. While system 100 is illustrated as containing a single electric vehicle, it should be understood that this is for simplicity only and that embodiments of system 100 may involve communication with multiple (e.g., 10, 100, 1000, 10,000) electric vehicles similar to electric vehicle 110-1.

Mobile device 120-1 may represent a cellular phone (e.g., a smartphone) of a person (also referred to as a user) that can communicate using one or more cellular networks and/or other forms of wireless networks. Mobile device 120-1 may be configured to capture location information, such as GPS data, that can be used to determine the location of mobile device 120-1. Such a mobile device 120-1 may be used in conjunction with an electric vehicle to determine where the electric vehicle is being driven. For example, the time the vehicle is unplugged from the EVSE, the colocation (via the mobile device's and/or the EVSE's location information) or closeness of the mobile device and the EVSE (based on a short-range radio (e.g., Bluetooth) link detection of each other's presence between the mobile device and the vehicle that is at a EVSE), and the subsequent speed of travel of the mobile device can be used to distinguish whether the device is traveling in the owner's electric vehicle or not. Alternatively, the user may connect the mobile to the electric vehicle via a wired or wireless interface. If a user possesses mobile device 120-1, the vehicle of the user may not report data to ESI 150. Mobile device 120-1 may be configured to interface with the electric vehicle and ESI 150. Mobile device 120-1 may gather data from an electric vehicle, such as the charge level of the vehicle's batteries. Mobile device 120-1 may also gather data from the user, such as whether or not the user wants the vehicle's batteries charged, where, how far, and/or when the user is intending to travel next, and/or how much the user is willing to pay for charging the vehicle. Such data may be transmitted by mobile device 120-1 to ESI 150 (or some other computer system). Alternatively, some or all of this information might be gathered by the vehicle supply equipment and communicated to ESI 150 or some other computer system. While system 100 is illustrated as containing a single mobile device, it should be understood that this is for simplicity only and that embodiments of system 100 may involve communication with multiple (e.g., 10, 100, 1000, 10,000) mobile devices similar to mobile device 120-1.

Wireless network 130 may represent one or more wireless networks, such as a cellular wireless network. While a single tower is illustrated, this is for illustration purposes only; multiple (e.g., hundreds) of wireless communication towers may be involved in communicating with electric vehicles and mobile devices. Network 140 may represent one or more public and/or private networks. Network 140 may include the Internet and/or a private corporate network.

ESI 150 may include a computer system configured to gather electricity usage information, including that of the electric vehicle's charge. This electricity usage information may be used by ESI 150 to predict electricity usage at points on the electrical grid 160 and/or modify electricity usage to decrease peak demand overall or geographically. ESI 150 may be configured to identify travel patterns of electric vehicle 110-1, users of electric vehicle 110-1 and/or mobile device 120-1 to anticipate electricity usage. ESI 150 may be in communication with electrical grid 160 to gather electricity usage and/or distribution data.

Electrical grid 160 may include multiple components. For example, electrical grid 160 may include multiple sub-grids that are each capable of distributing various amounts of electricity and/or reporting data regarding electricity usage. For example, electrical grid 160-1 may represent a major distribution grid that can distribute 20 megawatts to smaller distribution grids; electrical grid 160-2 may be capable of distributing 5 megawatts; and electrical grid 160-3 may be capable of distributing 4 megawatts. As such, the amount of power distributed by each sub-grid of electrical grid 160 may need to be managed and/or monitored. While only three sub-grids are illustrated, this is for example purposes only; electrical grid 160 may contain many more sub-grids, each of which may be further divided into additional sub-grids.

Interfaced with electrical grid 160 at one or more points is power generation 170. Power generation 170 may create the electricity that is distributed by electrical grid 160. Power generation 170 may include one or more power generation facilities. Various types of power generation facilities may be included in power generation 170, such as coal, wind, solar, nuclear, hydroelectric, natural gas, and diesel. Other types of power generation facilities may also be included. Some of such power generation facilities may be favored over others due to costs. Some may take more or less time to bring online (begin generating power for distribution) than others. Some of such power generation facilities may be only brought online in anticipation of or in response to a spike in demand.

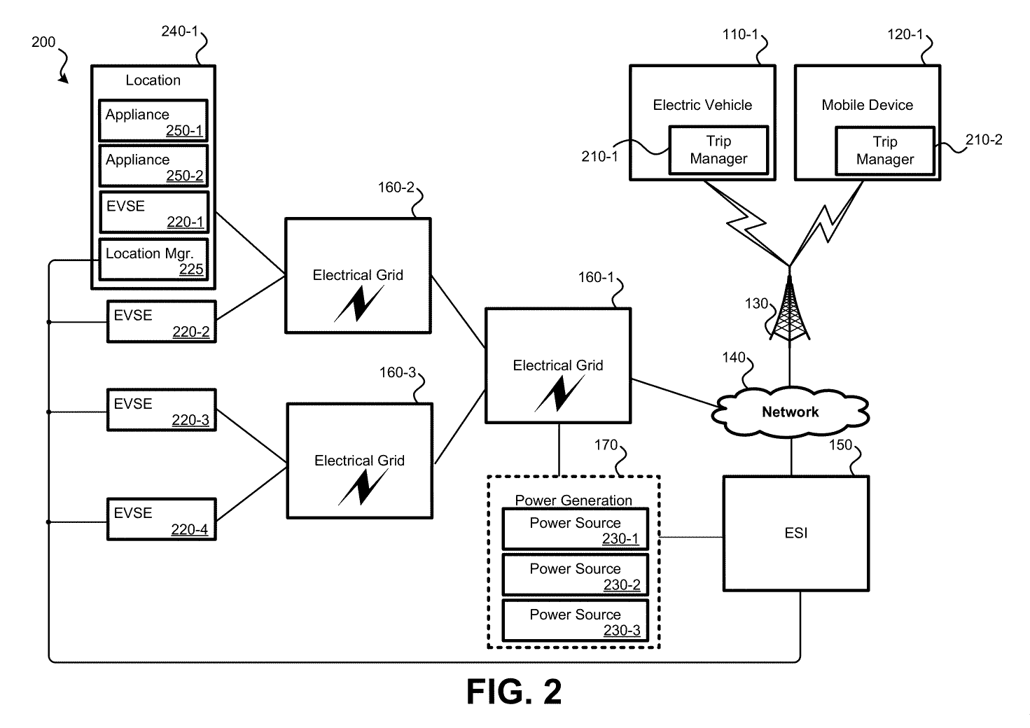

FIG. 2 illustrates a block diagram of another embodiment of a system 200 for electricity demand prediction. System 200 may represent a more detailed embodiment of system 100 or may represent a separate system for electricity demand prediction. System 200 may include: electric vehicle 110-1, mobile device 120-1, trip managers 210, wireless network 130, network 140, ESI 150, power generation 170, power sources 230, electrical grid 160, location 240, EVSE 220, location manager 225, and appliances 250.

Electric vehicle 110-1 may include trip manager 210-1. Trip manager 210-1 may be executed by a computerized system of electric vehicle 110-1. For example, trip manager 210-1 may be incorporated as part of a navigation system of electric vehicle 110-1. Trip manager 210-1 may be configured to receive user input and/or communicate with ESI 150 via wireless network 130 and/or network 140. Trip manager 210-1 may provide information to ESI 150 such as a budget defined by the user, charge and/or capacity information of electric vehicle 110-1′s batteries, estimated time of arrival, estimated location of arrival, and/or estimated time of departure information.

Such a trip manager may also reside on a mobile device. Mobile device 120-1 may include trip manager 210-2. Trip manager 210-2 on mobile device 120-1 may be a piece of software, firmware, and/or hardware. Trip manager 210-2 may be configured to receive information from an electric vehicle via a wired or wireless interface. As such, trip manager 210-2 may be able to determine when mobile device 120-1 is located within an electric vehicle. Trip manager 210-2, for example, using an identifier of an electric vehicle, may be able to identify the particular electric vehicle that mobile device 120-1 is within. Trip manager 210-2 may be configured to communicate with ESI 150. Trip manager 210-2 may be configured to provide similar information to ESI 150 as trip manager 210-1. Similarly, trip manager 210-2 may be configured to receive user input from a user, such as a budget defining an amount of money that the user is willing to pay for electricity to charge the batteries of an electric vehicle or an amount that the user desires to bid in an auction for electricity to charge an electric vehicle's batteries.

Power generation 170 is illustrated as containing three power sources 230. Each of these power sources may represent a different type of power generation. For example, power source 230-1 may be a diesel power generation facility. Power source 230-2 may be a natural gas powered generation facility. Power source 230-3 may be coal powered. Some or all of these power sources may have different power generation capabilities and/or may take different amounts of time to bring online. ESI 150 may be in communication with some or all of power sources 230. ESI 150 may be used to provide an operator of each of the power sources information regarding anticipated demand for power. This information may be used by the operator of power sources 230 to determine which power sources should be brought online or taken off-line. In some embodiments, ESI 150 may be configured to automatically trigger one or more power sources 230 to come online or go off-line. ESI 150 may also be configured to increase or decrease power generation at one or more power sources.

Electrical grid 160-3 is illustrated as connected with EVSE (Electric Vehicle Supply Equipment) 220-3 and EVSE 220-4. An EVSE may be used to charge one or more electric vehicles. EVSE 220-3 and EVSE 220-4 may be located at the same location (e.g., the same home or the same building) or may be located at different locations (e.g., two homes that are connected with electrical grid 160-3). While EVSE 220-3 and EVSE 220-4 may be located at different locations, it may be possible for ESI 150 to control the timing of charging using these EVSEs, and the rate of charging. While electrical grid 160-3 is illustrated as connected to two EVSEs, it should be understood that this is for illustration purposes only. Many additional EVSEs and/or other equipment that requires electrical energy may be connected with electrical grid 160-3. For example, all homes within a neighborhood may be connected with electrical grid 160-3.

Electrical grid 160-2 is illustrated as connected with EVSE 220-2 and location 240-1. EVSE 220-2, EVSE 220-3, and EVSE 220-4 may also be located at locations similar to location 240-1. Location 240-1 may represent a home, an office building, or some other location that has multiple electricity consuming devices. Location 240-1 contains EVSE 220-1, appliance 250-1, and appliance 250-2. Location 240-1 also may contain location manager 225. Location manager 225 may serve to manage and report on electricity consumption of various electricity consuming devices located at location 240-1. Location manager 225 may provide electricity usage information to ESI 150. ESI 150 may provide instructions on electricity usage to location manager 225. Electrical grid 160-2 is illustrated as connected with two entities: EVSE 220-2 and location 240-1. It should be understood that this is for illustration purposes only; electrical grid 160-2 may be connected with a greater number of locations and/or EVSEs.

EVSEs 220 may communicate, either wirelessly or via wireline (e.g., powerline based communication) with ESI 150. EVSEs 220 may gather information related to electric vehicles' locations, times of arrival (based on plugging in and unplugging), time of departure (again, based on plugging in and unplugging), level of charge while plugged in and other information independently from the vehicles themselves. Such information may be shared with ESI 150.

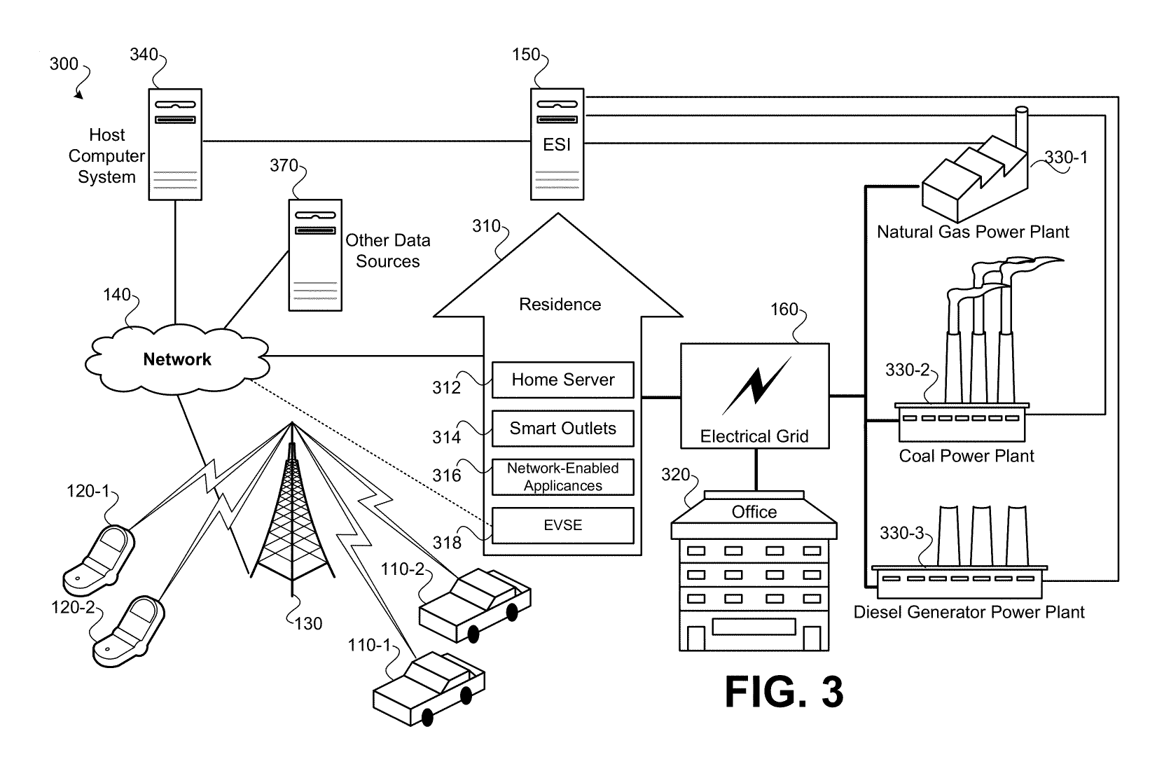

FIG. 3 illustrates a block diagram of another embodiment of a system 300 for electricity demand prediction. System 300 may represent an alternate and/or more detailed embodiment of system 100 and/or system 200. In system 300, information is collected from a variety of network-enabled devices. This information may be used to anticipate a time and/or a magnitude of demand for electricity. Such network-enabled devices may include mobile devices 120, which may be cellular phones, tablet computers, laptops, etc. Such network-enabled devices may also include electric vehicles 110 that communicate with a wireless network. Electric vehicles 110 may include passenger vehicles and fleet vehicles. Electric vehicles 110 and mobile devices 120 may communicate via one or more wireless networks 130 with a host computer system 340. Communication with host computer system 340 may occur via network 140.

Network-enabled devices may also include various devices typically found at a residence 310 (or some other location, such as an office, factory, etc.). For example, network-enabled appliances 316 (e.g., washers, dryers, lights, stoves, furnaces, water heaters, air conditioners, dishwashers, televisions, blenders, freezers, refrigerators, stereos, and fans) may be able to communicate (wirelessly or via a wire) with home server 312. Home server 312 may be a location manager 225 for a home. Network-enabled appliances 316 may also include smart electrical meters and/or home sensors. Network-enabled devices may also include smart outlets 314, which are outlets that collect information regarding electricity usage from plugged-in devices. Such information may include the amount of time devices are powered up, when the devices are powered up, and the amount of electricity consumed by the devices. As such, smart outlets 314 may be used to gather electricity use information from appliances or other devices that consume electricity but are not network-enabled. EVSE 318 may provide electricity usage information. Information about consumed electricity may be transmitted from EVSE 318, network-enabled appliances 316, and smart outlets 314 to home server 312 or directly to host computer system 340 via network 140. In some embodiments, EVSE 318 may communicate via network 140 without the use of home server 312. For instance, EVSE 318 may report an electric vehicle's location, time of arrival, and time of departure (e.g., based on plugging in and unplugging), level of charge while plugged in, and/or other information independently from the vehicles themselves to host computer system 340 and/or ESI 150. Home server 312 may collect and analyze the received electricity usage information. Home server 312 may transmit information regarding electricity usage, including separate categories for electric vehicles, appliances, heating, lighting, etc., gathered from such devices at residence 310 to host computer system 340 via network 140. Information from other network-enabled devices may be gathered from other residences and/or other locations, such as office 320.

While one residence 310 and one office 320 are illustrated, it should be understood that electricity usage information may be gathered from a much greater number of locations, such as thousands of residences and/or offices. Similarly, while only two mobile devices 120 and two electric vehicles 110 are illustrated, it should be understood that information may be gathered from many more network-enabled devices.

Host computer system 340 may receive electricity usage information from a plurality of locations, such as EVSE 318, residence 310, and office 320. Host computer system 340 may use such electricity usage information to predict future electricity usage. Information from residence 310, office 320, and other locations may be used in conjunction with information gathered from mobile devices 120 and electric vehicles 110. For example, mobile device 120-1 may be linked with a resident who lives at residence 310. Since electricity usage typically increases at a residence when a resident is home, location information gathered from mobile device 120-1 may be used to predict when electricity consumption at residence 310 will increase. If the resident carries mobile device 120-1, the resident's travel pattern may be identified by host computer system 340 observing the location of mobile device 120-1 over a period of time. For example, by observing the location information of mobile device 120-1, it may be determined that the resident works Monday through Friday in office 320, commutes approximately 30 minutes to residence 310 in the late afternoon, and uses approximately 800 watts of power while home. As such, when location information from mobile device 120-1 indicates to host computer system 340 that the resident has begun his commute home from office 320 to residence 310, host computer system 340 can estimate that in about 30 minutes power consumption at residence 310 will increase by approximately 800 watts. Additionally, host computer system 340 may use the charging history of electric vehicle 110 to predict its next charging location, time, duration, and/or amount. This may be accomplished alone or together with other information of host computer system 340.

Location information may also be gathered from mobile device 120-2 which may be associated with some other person who lives at some other residence. Location information may also be gathered from electric vehicles 110-1 and 110-2. This location information may be used by host computer system 340 to identify various travel patterns of the electric vehicles 110 and of persons in the vehicles. (Alternatively or additionally, these travel patterns may be identified and stored by mobile devices 120 or electric vehicles 110.) Host computer system 340 may use location information and power consumption information in conjunction with other data sources. Other data sources 370 may indicate other sources of information that host computer system 340 may use to predict electricity consumption. For example, other data sources 370 may include weather information (for example, power consumption may tend to increase when the weather is very hot because more people tend to turn on the air conditioner) and calendar information (e.g., power consumption may tend to decrease in offices, such as office 320, on holidays because offices are closed). Other data sources 370 may include still other sources of data relevant to power consumption.

Host computer system 340 may identify travel and/or charging patterns of electric vehicles 110 and persons linked with mobile devices 120. In conjunction with this information, the amount of electricity consumed at residences where the persons reside and/or other locations where the persons tend to travel to, such as office 320, may be determined. Host computer system 340 may use all of such information to predict the amount of electricity that will be needed at various times and/or locations in the future to satisfy demand. Information regarding the prediction of such demand for electricity may be transmitted to ESI 150. ESI 150 may control which and to what extent various electricity generation sources generate electricity. FIG. 3 shows three example electricity generation sources 330-1, 330-2, and 330-3. For example, coal power plant 330-2 may continuously provide at least some amount of electricity to electrical grid 160 (represented in FIG. 3 as a single entity). Natural gas power plant 330-1 may be powered down or powered up depending on the amount of power demanded by electrical grid 160. It may take a certain amount of time, such as between 30 minutes and two hours, to power up natural gas power plant 330-1. As such, in order for natural gas power plant 330-1 to satisfy a spike in demand for electricity on electrical grid 160, ESI 150 may need to give natural gas power plant 330-1 a lead time, such as between 30 minutes and two hours, to power up. Diesel generation power plant 330-3 may use diesel generators to generate electricity for electrical grid 160. Diesel generators may take a very short amount of time to power off, such as just a few minutes, however may be expensive to operate and/or may generate significant pollution. As such, if ESI 150 is informed ahead of an impending spike in demand for electricity on electrical grid 160, use of diesel generation power plant 330-3 may be decreased or eliminated. In some embodiments, host computer system 340 may be combined with ESI 150. In some embodiments, multiple host computer systems may be present, each host system providing data to ESI 150.

When host computer system 340 anticipates that a spike in demand is likely going to occur at a specific location or region, such as based on 1) location information gathered from mobile devices 120, electric vehicles 110 and EVSEs 220 and 318; 2) power usage at residence 310 (and other locations, such as other residences, factories, and offices, such as office 320); and 3) travel patterns of residents linked with mobile devices 120, the host computer system 340 may alert ESI 150 of an anticipated spike in demand for electricity, the size of the anticipated spike, and/or the anticipated duration of the anticipated spike. ESI 150 may then be used to increase production of electricity by a (more) efficient source, such as natural gas power plant 330-1 instead of diesel generation power plant 330-3.

It should be understood that in order for host computer system 340 to anticipate a spike in demand for electricity usage, every vehicle, every residence, or every office that is connected with electrical grid 160 does not need to be in communication with host computer system 340. Rather, as long as enough residences, offices, vehicles, and mobile devices are in communication with host computer system 340, host computer system 340 may be able to predict electricity usage accurately enough to anticipate a change in demand.

In addition to host computer system 340 receiving location information and power usage information, host computer system 340 may actively control which network-enabled devices are powered up. For example, a host computer system 340 may communicate with home server 312 at residence 310 via network 140 to inform home server 312 to power up an air conditioner at a particular time, such as ahead of arrival of a resident. In some embodiments, host computer system 340 may communicate with network-enabled appliances 316 at residence 310 without use of home server 312. Rather than appliances, such as air conditioners, being powered up at various residences (or other locations) at the same time, host computer system 340 may coordinate which air conditioners turn on first, possibly based on the location of mobile devices linked with the residents, and/or the travel patterns of the residents, such that one air conditioner may be turned on earlier than another air conditioner and turned off later in favor of another air conditioner (or some other device that consumes electricity) at a different residence, such that both residents arrive to a cooled environment.

Host computer system 340 may also at least partially control the timing and rate of electric vehicle charging. If one or more of electric vehicles 110 are electric (e.g., fully electric or a plug-in hybrid), an EVSE, such as EVSE 318, may be used to charge the vehicle. EVSE 318, and similar electric vehicle chargers, may use significant amounts of electricity. Based on the travel patterns of one or more persons who use the electric vehicle being charged (and/or the travel patterns of the vehicles themselves), the charging location time, and/or the amount pattern of the vehicle, a time and/or rate for charging electric vehicles may be determined. Additionally, the current amount of charge present in the batteries of the vehicle may be considered. For example, if the battery of the vehicle is almost completely drained, priority to charge the vehicle may be increased in comparison to a situation where the battery of the vehicle is only slightly drained. If, according to the charge and/or travel pattern of the vehicle and/or drivers linked with the vehicle, the vehicle is expected to be driven shortly, priority may be given to charge the batteries of the vehicle and/or the charge may be conducted at a higher charging rate. If, according to the charge or travel pattern of the vehicle and/or drivers linked with the vehicle, the vehicle is not expected to be driven shortly, priority may be given to charge the batteries of other vehicles and/or the vehicle may be discharged to help the electrical grid.

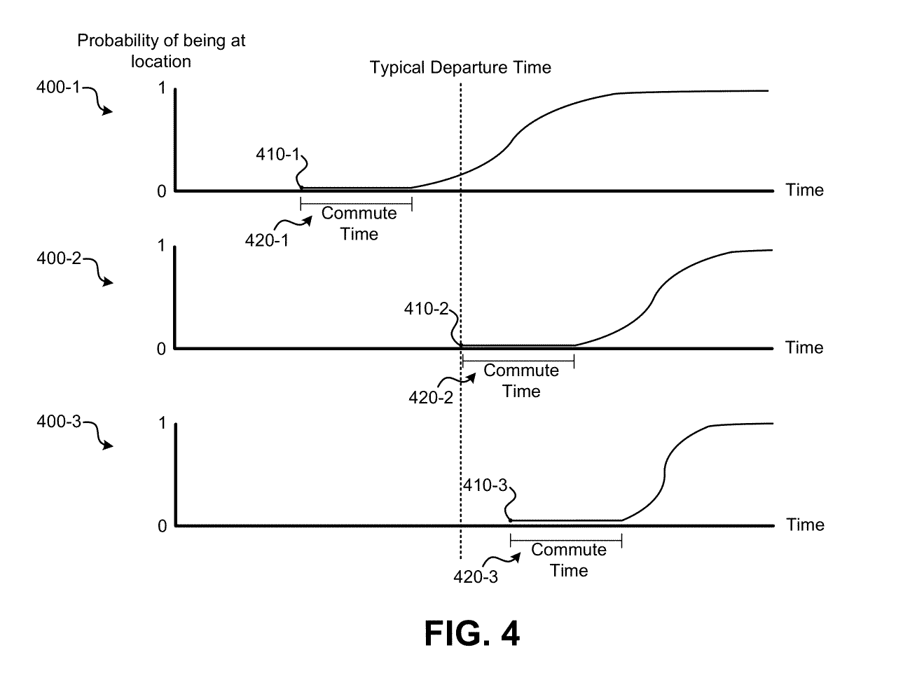

FIG. 4 illustrates an embodiment of graphs 400 comparing a departure time from an origination location and the probability of being at a destination. When a person leaves a first location to drive to a second location, the amount of time to complete the drive may be approximately the same day-to-day. For example, if a person leaves work at approximately the same time each day, the amount of time to commute home may be approximately the same each day or may be based on a current traffic report or forecast estimate. For example, if a person leaves work at 4:30 PM or 5:30 PM, the person's commute may remain approximately 30 minutes. Further, the later in the day, it may be more likely the person will leave work and go directly home. Graphs 400 illustrates three possible probability representations of a person leaving a first destination, such as work, to go to a destination, such as home.

In graph 400-1, at time 410-1, it may be determined that a person is leaving work. This may be based on determining that the user has entered his or her vehicle, is leaving the building, or the electric vehicle has been unplugged from EVSE 318. Based on previous location measurements, it may be known that it takes approximately a first period of time for the person to commute home. This first period of time is indicated as commute time 420-1. As such, since the person's commute takes approximately commute time 420-1 to complete, when the person leaves work it is known that the person will not be home approximately at least until commute time 420-1 is complete. Further, the person may not go directly home. As such, once the commute time has elapsed, the probability of the person being at home gradually increases. Alternatively, the electric vehicle might be plugged into a shopping mall's (or some other location's) EVSE, indicating that the person did not go home directly after work but instead has gone shopping (or somewhere else). Previous records of such a work-second location-home pattern can be used to predict the time spent at the second location and the estimated time the vehicle will start charging at home.

If the person departs later, such as at typical departure time 4:30 PM, the user may not arrive home approximately at least until commute time 420-2 elapses. Commute time 420-2 may be the same length of time as commute time 420-1, or may be adjusted to compensate for the difference in expected traffic since the person is leaving work later. Since the person is leaving work later, it may be more likely that the person will go directly home. Referring to graph 400-3, the person may have left work still later. Again, the user may not arrive home at least until commute time 420-3 has elapsed. Since the person is leaving work later than in graph 400-2, it may be more likely that the person will go directly home.

Such calculations of the probability of going home based on a person's commute time and time of departure compared to the person's typical departure time may allow for a determination of when the user is expected to arrive at the location, such as home. Such a determination may be useful in anticipating an electrical load at the destination and/or modifying electrical usage (such as at the destination) to reduce (peak) demand for electricity.

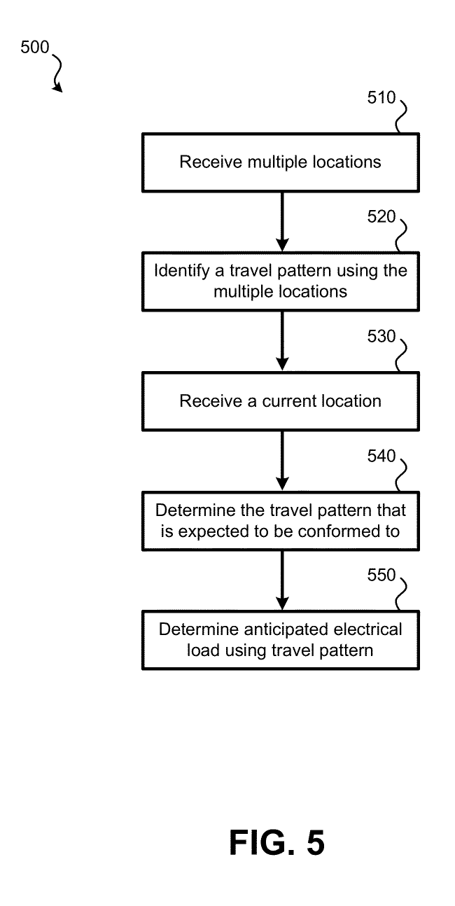

FIG. 5 illustrates an embodiment of a method 500 for electricity demand prediction. Method 500 may be performed by system 100, system 200, system 300, or some other system that is configured to perform electricity demand prediction. Each step of method 500 may be performed using a computer system (which may include one or more individual computers). At step 510, multiple indications of location may be received. These location indications may indicate the position of a mobile device and/or a vehicle. These location indications may be GPS coordinates or some other form of location coordinates that indicate a position on the earth. Referring to system 200 of FIG. 2, trip manager 210-1 of electric vehicle 110-1 may collect and provide location information to a remote computer system. Similarly, trip manager 210-2 of mobile device 120-1 may collect and provide location information to a remote computer system. The multiple locations of the vehicle or mobile device may be gathered over a period of time, such as hours, days, weeks, and/or months. As an example, when a vehicle is in motion, location data regarding the vehicle may be gathered once per minute.

Using the multiple indications of location received at step 510, one or more travel patterns may be identified. As an example, if the indications of location received at step 510 were collected over a period of at least a week, the locations may collectively indicate that the vehicle (or mobile device) usually follows a particular route in the late afternoons, Monday through Friday. An origination and destination may also be identified. This travel pattern may represent the vehicle being used for a commute home from work, or a person otherwise commuting home (e.g., taking a bus). As such, one travel pattern that may be identified is a commute home from work. Other travel patterns that may be identified may include: a commute to work, a drive to a daycare facility, a drive home from a daycare facility, a trip to the grocer, etc.

At step 530, one or more indications of current location of the vehicle may be received. At step 540, based on the one or more indications of current location received at step 530, it may be determined that the vehicle is expected to conform to the travel pattern identified at step 520. For example, at step 530, an indication of a current location may be received that indicates that the vehicle is parked near where a travel pattern identified at step 520 usually begins. Further, another indication of the current location of the vehicle may indicate that the vehicle has left the parking location and is conforming to travel along an initial portion of the route indicated by the travel pattern. As such, because the vehicle originated from the same starting point (the parking location) and is headed in the same direction, it may be determined that the vehicle is expected to conform to the travel pattern. Other factors may also be considered when determining if the person operating the vehicle (or possessing the mobile device) is expected to conform to the travel pattern. For example, the day of the week and/or the time of the day may be used in making such a determination.

At step 550, an anticipated electrical load may be determined using the travel pattern. It may be known typically how long it takes the person to complete the travel pattern. For example, if it usually takes 30 minutes to commute from the beginning of the travel pattern to the destination, it may be anticipated that the electrical load will increase at the destination in approximately 30 minutes' time once following of the travel pattern begins. Determining an anticipated electrical load may include only determining when the electrical load is expected to increase. In some embodiments, determining the anticipated load may also include determining where the electrical load is anticipated to increase and/or by how much. The travel pattern may indicate the destination of the person. Based on this destination, at step 550 it may be determined where the anticipated electrical load is expected to occur (such as, which electrical grid is expected to sustain an increased load and/or what address). Further, based on the travel pattern, vehicle, and/or the identity of the person, the magnitude of the anticipated electrical load may be identified. For example, while two people may commute at the end of the day to the same destination (e.g., their home), one person may tend to use more electricity upon return than the other (e.g., one tends to immediately leave the home again and go running, while the other tends to turn on the television, washing machine, EVSE, and air conditioner).

At step 550, while the anticipated electrical load at the destination may be determined. A decrease in anticipated load may be determined for the location where the vehicle is originating from. For example, if a current location of a vehicle is at work being charged and the vehicle leaves, the future anticipated electrical load for at work may decrease (because the vehicle is not expected to be charged there for at least a period of time into the future). It should be understood that in some embodiments, the location a vehicle originates from may also be the destination (e.g., the vehicle may be driven in a “loop”). For example, a person may drive a vehicle to the park from his or her home and then return home. As such, the anticipated electrical load at the destination may be the location from which the vehicle left. As another example, a travel pattern may indicate that the vehicle is being used to run errands and that charging is anticipated to occur when the vehicle returns home after a period of time of being used for errands.

Some or all steps of method 500 may be performed by a remote computer system that receives data from one or more electric vehicles and/or mobile devices. For example, referring to system 300 of FIG. 3, host computer system 340 may receive such indications of location from multiple mobile devices and/or multiple vehicles. In some embodiments, a similar method may be performed by ESI 150. Referring to system 200 of FIG. 2, a trip manager executed by an electric vehicle or by a mobile device may perform the steps of the method 500. Such a trip manager may receive location information from a GPS sensor (or some other location determining device), identify one or more travel patterns locally, receive current locations of the vehicle or mobile device, and determine whether the vehicle or mobile device is expected to conform to a previously identified travel pattern. The trip manager may then notify a host computer system or ESI of information such as: a destination, the identity of the person, and/or an estimated time of arrival. The host computer system or ESI may determine the anticipated electrical load based on the information received from the trip manager and/or from another source such as home server 312 of system 300. Alternatively, the anticipated electrical load may be determined at the trip manager (which also may receive data from sources such as home server 312 of system 300); then the trip manager transmits it to the host computer system and/or ESI. Using a trip manager to identify and store travel patterns may be preferable due to privacy concerns of the person (for example, having a remote system storing data regarding the person's travel patterns).

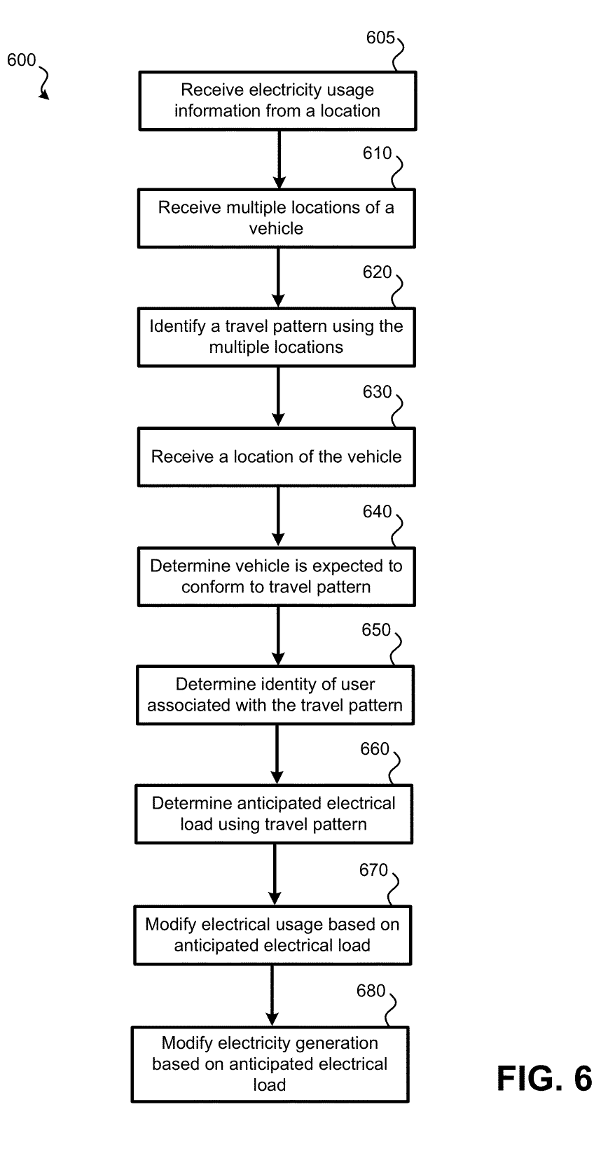

FIG. 6 illustrates an embodiment of a method 600 for electricity demand prediction and modifying electricity usage in response to such a prediction. Method 600 may represent a more detailed embodiment of method 500 or a separate method. Method 600 may be performed by system 100, system 200, or by system 300. Alternatively, some other system configured to perform electricity demand prediction and modify electricity usage may be used to perform method 600. Each step of method 600 may be performed by a computer system, such as a host computer system or an ESI.

At step 605, electricity usage information may be received from a location. This electricity usage information may indicate typical electricity usage by specific electrical devices or by all electric devices present at the location. Referring to system 300, the electricity usage information may indicate the amount of electricity used by specific network-enabled appliances 316, smart outlets 314, and by EVSE 318. The electricity usage information may indicate the collective amount of electricity used by all electric devices at residence 310 (e.g., smart outlets 314, network-enabled appliances 316, and EVSE 318). The electricity usage information may indicate the amount of electricity used for specific time periods, such as per hour. The electricity usage information may be received by a computer system such as host computer system 340 or ESI 150 from home server 312. Similarly, in system 200, ESI 150 may receive electricity usage information from location manager 225 of location 240-1. Location 240-1 may represent a residence (such as residence 310 of system 300), an office (such as office 320 of system 300), or some other location where multiple electrical devices consume electricity. Such electricity usage information may be received from multiple locations. In some embodiments, the electricity usage information may be stored by a trip manager, such as a trip manager executed by a mobile device.

The electricity usage information from the location may be linked with one or more specific persons. For example, if a first and second person reside at residence 310 of system 300, electricity usage information for when only the first person is present at residence 310 may be maintained distinct from electricity usage information for when only the second person is present at residence 310. Electricity usage information may also be maintained for when both persons are present at residence 310. The electricity usage information received at step 510 may be used to anticipate the amount of electricity that is expected to be used when one or more of the persons arrive at a location.

Steps 610 through 640 correspond to previously detailed steps 510 through 540 of method 500 of FIG. 5. At step 650, an identity of the person associated with the travel pattern may be determined. The identity of the person may be based on the travel pattern. For example, a particular travel pattern may typically only be followed by a particular person. The identity of the user may also be based on the vehicle and/or the mobile device from which location information is being received. It may be assumed that a particular mobile device, such as a cellular phone, is always associated with a particular person. A similar association may be present for vehicles.

At step 660, an anticipated electrical load may be determined using the travel pattern. It may be known approximately how long it takes the person to complete the travel pattern. For example, referring to graph 400-2 of FIG. 4, once a person has begun following a travel pattern, it may be known that commute time 420-2 is typically 45 minutes long. Determining the anticipated electrical load may also include determining where the electrical load is anticipated to increase and/or by how much. The travel pattern may indicate the destination of the person. Based on this destination, at step 550 it may be determined where the anticipated electrical load is expected to occur (such as, which electrical grid is expected to sustain an increased load). Further, based on the travel pattern, vehicle, anticipated destination and/or the person, the magnitude of the anticipated electrical load may be identified using the electricity usage information received at step 605. As an example, if the travel pattern indicates the person is expected to arrive at the destination at 5 PM, the electricity usage information received at step 605 may be analyzed to determine typical electricity usage of the destination at 5 PM and/or when the user arrives at the destination location. Other factors may also be used to anticipate the electrical load, such as: one or more additional persons who will be arriving at the location and/or persons who are already present at the location, the time of day, and/or the day of week.

At step 670, electricity usage may be modified based on the anticipated electrical load. Electricity usage may be modified at the location where the user is expected to arrive, and/or at one or more other locations. For example, one way in which electricity usage may be modified is by accelerating charging of an electric vehicle at another location such that charging will be complete or can be slowed for when the anticipated electrical load at the destination location is expected to be realized. As such, electricity usage at the location or some other location may be increased ahead of the anticipated electrical load such that the electricity usage can be decreased when the anticipated electrical load is expected to be realized. At the location where the anticipated electrical load is expected to be realized, the electrical load may be reduced by staggering electricity usage. For example, charging of an electric vehicle may be delayed at the location until a time when electricity usage is lower.

One or more electricity generation sources may be brought online in anticipation of the anticipated electrical load. For example, if the aggregate anticipated electrical load for many locations indicates that in approximately one hour a significant increase in electrical load will be realized grid-wide, an electricity generation source that takes approximately an hour to bring online may be activated. Referring to system 300 of FIG. 3, a power generation source, such as a natural gas power plant, may be brought online in anticipation of the aggregate anticipated electrical load instead of a less efficient power generation source, such as a diesel power generation facility, that takes less time to be brought online. At step 680, electricity generation may also be modified by taking one or more electricity generation sources off-line.

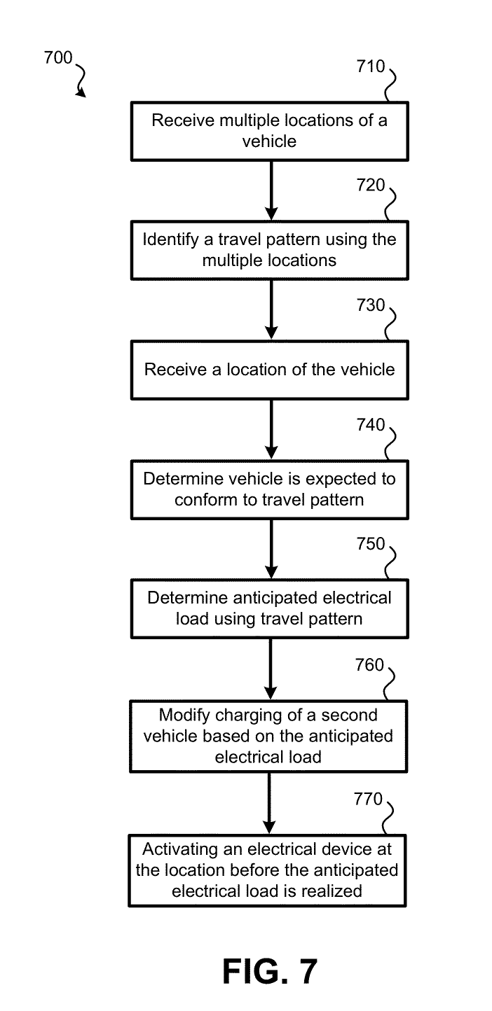

FIG. 7 illustrates an embodiment of a method for electricity demand prediction and modifying electricity usage. Method 700 may represent a more detailed embodiment of method 600 or a separate method. Method 700 may be performed by system 100, system 200, or by system 300. Alternatively, some other system configured to perform electricity demand prediction and modifying electricity usage may be used to perform method 700. Each step of method 700 may be performed by a computer system, such as a host computer system or ESI. Steps 710 through 750 correspond to steps 510 through 550 of method 500 of FIG. 5.

At step 760, the charging of an electric vehicle may be modified based on the anticipated electrical load. This electric vehicle may be located at the same or different location from where the anticipated electrical load is expected to be realized. Modifying the charging of the second electric vehicle may include accelerating the charging process such that at least a portion of the charging process is completed ahead of the anticipated electrical load. Modifying the charging of the second electric vehicle may also include stopping the charging process when the anticipated electrical load is expected to begin or actually begins. If charging is not complete when the charging process is stopped, charging will continue at a lower rate or may resume at a later time (such as when the electrical load on the electrical grid providing service has decreased). Modifying charging may be at least partially based on the load being experienced by a distribution grid. For example, referring to FIG. 2, if electrical grid 160-2 and electrical grid 160-3 each have the ability to charge two electric vehicles, and electrical grid 160-1, from which both electrical grid 160-2 and electrical grid 160-3 draw electricity, has the ability charge only three electric vehicles, either electrical grid 160-2 or electrical grid 160-3 may only charge one electric vehicle while the other is charging two electric vehicles. As such, modifying the charging of an electric vehicle may involve accelerating or delaying the charging of an electric vehicle on a first grid (e.g., electrical grid 160-3) to permit charging of another electric vehicle on a second grid (e.g., electrical grid 160-2). The timing of when a vehicle is charged and/or the rate of the charging may be referred to as the vehicle's “charging schedule.”

At step 770, one or more electrical devices at the location where the anticipated electrical load is expected to be realized may be activated ahead of the anticipated electrical load. As such, at the time the anticipated electrical load is expected to be realized, the electrical devices may not need to be provided power. An air conditioner may be an example of an electrical device which may be used in such a manner. If a user, upon returning home, typically turns on an air conditioner, rather than waiting until the user arrives home to activate the air conditioner, the air conditioner could be activated in anticipation of the user returning home. When the user arrives home, the air conditioner may have sufficiently cooled the house such that the air conditioner no longer needs to be turned on. As such, rather than multiple electrical devices needing to be turned on when the user returns home, such as the air conditioner, an EVSE, lights, and a television, the air conditioner would have already run, thus decreasing the peak demand of electricity at the home. Preemptively turning on an electrical device such as an air conditioner may be controlled by a host computer system, an ESI, and/or location manager (such as a home server). For instance, at step 770, an indication that an electrical device should be activated may be received by a location manager from a host computer system or an ESI. In some embodiments, it may be possible for the host computer system or the ESI to contact the electrical device directly.

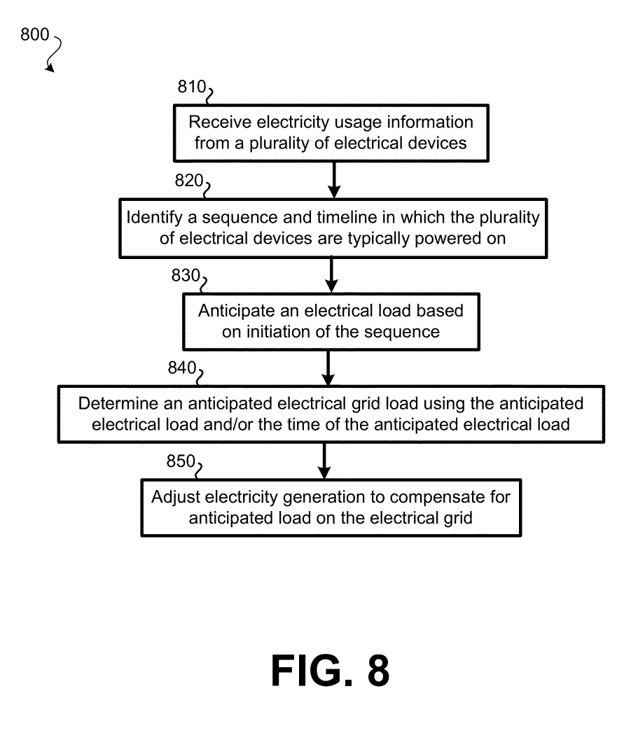

FIG. 8 illustrates an embodiment of a method for anticipating electricity usage based on a sequence of devices being powered up. Method 800 may be performed by system 100, system 200, or by system 300. Alternatively, some other system configured to perform electricity demand prediction and modifying electricity usage may be used to perform method 800. Each step of method 800 may be performed by a computer system, such as a host computer system or ESI. Some steps of method 800, such as step 810 through step 830, may be performed by a location manager, while the remainder of the steps may be performed by a remote computer system, such as a host computer system and/or ESI.

When a network-enabled device is powered up, other network devices may also typically be powered up, be it at the same time or at some time following the first network-enabled device being powered on. For example, when a washing machine is powered on, a dryer, such as an hour later, may typically be powered on. Similarly, as another example, when a garage door opens in the evening, this may be followed by lights being turned on, a television being turned on, and a stove being turned on, in quick succession. As such, various patterns in the powering up of devices may be determined. These patterns may be used to predict electricity usage information for a particular location and for an electrical grid.

At step 810, electricity usage information may be received from a plurality of electrical devices, such as smart outlets, network-enabled appliances, and electric vehicle chargers. Such electricity usage information may be received by a home server such as home server 312 or a host computer system such as host computer system 340 of FIG. 3. This electricity usage information may include information on the time and amount of electricity used by the electrical devices. At step 820, a sequence and/or timeline in which the electrical devices are powered on may be identified using the electricity usage information received at step 810.

At step 830, an electrical load is anticipated based on initiation of the sequence. For example, if at step 820 a washing machine being turned on is identified as being the first step in the sequence of several electrical devices being powered up, a future electrical load at step 830 may be anticipated based on the washing machine being powered up. At step 840, an anticipated electrical load on an electrical grid is determined using the anticipated electrical load at step 830. This anticipated electrical load on the electrical grid may factor in the time at which various electrical devices are anticipated to be powered up as part of the sequence.

At step 850, the amount of electricity generated may be adjusted to compensate for the anticipated load on the electrical grid. For example, if the anticipated load includes a spike in demand, additional electricity generation sources may be brought online. If the anticipated load is less than the current load on the electrical grid, electricity generation sources may be prepared to go off-line.

Method 900 through method 1200 focus on the charging of electric vehicles. Such electric vehicles may be electric-only, gas-electric hybrids, or some other form of vehicle that requires plug-in charging using electricity. Each of such methods may be performed when an electric vehicle is to be charged. For example, referring to system 200, electric vehicle 110-1 may be connected with EVSE 220-1 at location 240-1 for charging. In system 300 of FIG. 3, electric vehicle 110-2, may be connected for charging at residence 310 to EVSE 318 and/or may be connected to an EVSE at office 320. (For example, the person's commute may be long enough that charging is required at both residence 310 and office 320, or charging may be spread between the two locations such that charging may be accomplished at a lower rate.) The following methods detail various arrangements for handling the charging of electric vehicles, especially if additional electric vehicles are to be charged simultaneously, thus increasing the demand for electricity.

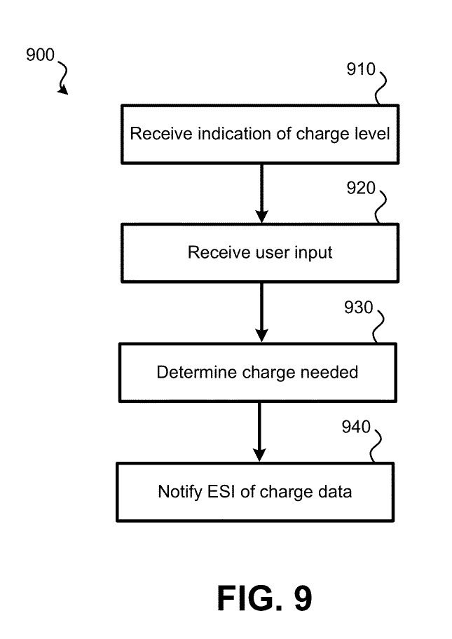

FIG. 9 illustrates an embodiment of a method for notifying an ESI (Electrical Service Interface) of vehicle charging information. Method 900 may be performed by system 100, system 200, or by system 300. Alternatively, some other system configured to perform electricity demand prediction and modifying electricity usage may be used to perform method 700. Each step of method 900 may be performed by a computer system, such as a trip manager executed by an electric vehicle or mobile device.

At step 910, an indication of a charge level may be received. This charge level may be received by the trip manager, directly or indirectly, from a sub-system of the electric vehicle that measures the charge level of the electric vehicle's battery (or batteries).

At step 920, user input may be received by the trip manager. The user input may specify various data that is relevant to the vehicle and/or charging of the vehicle. Data that may be provided by the user includes: information on where the vehicle is anticipated to be driven next, information on when the vehicle is anticipated to be driven next, how much the batteries should be charged, and/or an amount of money willing to be paid for charging. At step 930, some of this information may instead be anticipated by the trip manager. For example, the trip manager, rather than receiving an indication of where and when the vehicle may be driven next, may make such a determination based on previous travel patterns, the day of the week, the time of day, etc. Using this information the trip manager may determine a level of charging that is likely needed. Other factors may also be considered, such as a minimum level of charging of the vehicle's batteries. For example, the user may have specified a preference that the vehicle's batteries always be charged above 60%.

At step 940, some or all of this information may be sent to the ESI. The ESI may receive an indication of an amount of charge requested by the trip manager. The trip manager may provide a deadline for when the charge is requested. For example, the trip manager may specify that 12 kWh of electricity is requested for charging the vehicle and that the charging should be completed by 3:00 PM. The ESI may then manage the timing and rate of the charging of the vehicle via an EVSE.

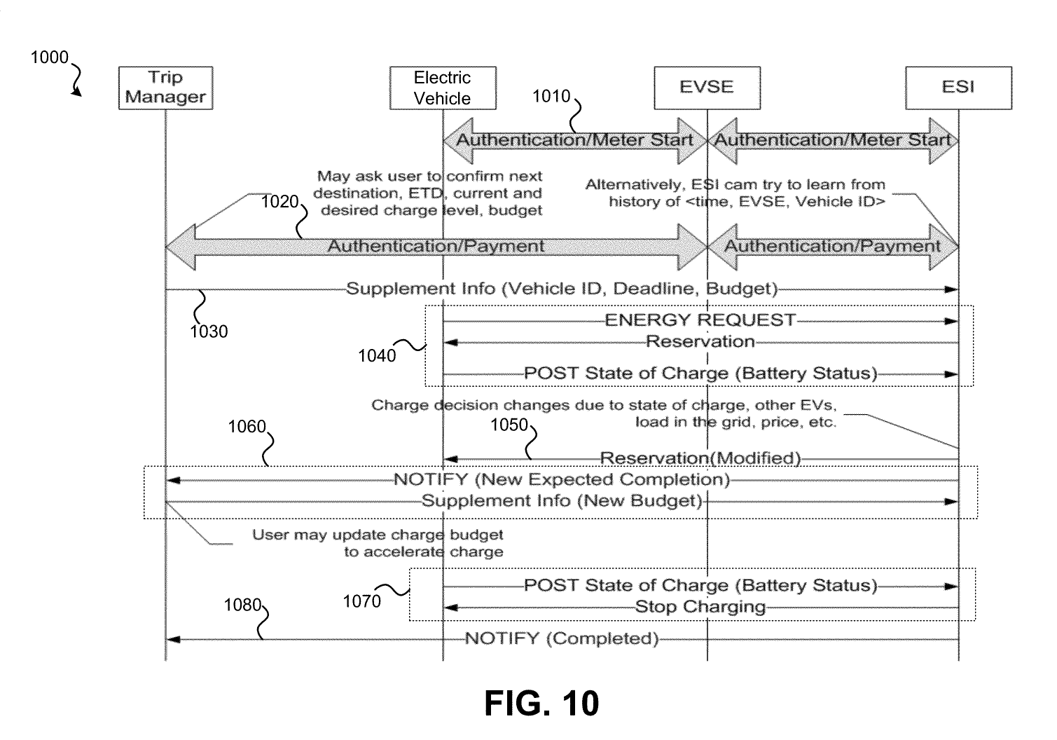

FIG. 10 illustrates a swim diagram of an embodiment of a method 1000 for managing the charging of an electric vehicle. Method 1000 focuses on a budget being submitted by a user that defines one or more prices that the user is willing to pay for electricity to charge the vehicle. In many situations, the greater the price indicated by the user, the more likely and/or the faster the user's electric vehicle will be charged. Method 1000 involves communication between a trip manager, such as trip manager 210-2 of system 200 of FIG. 2, an electric vehicle, an EVSE (that is used to charge the electric vehicle), and an ESI, such as ESI 150 of FIG. 2.

At step 1010, authentication may occur between the electric vehicle, the EVSE, and the ESI. This may involve the electric vehicle providing a vehicle identifier. The ESI may receive an indication such that it knows the identifier of the electric vehicle and which EVSE the electric vehicles are connected with. Such authentication may also include starting a meter measurement such that the amount of electricity used to charge the electric vehicle is accurately measured. At step 1020, authentication and payment may occur between the trip manager, the EVSE, and the ESI. Various information may be gathered from the user by the trip manager at step 1020. For example, the user may be prompted to provide an indication of the next destination that the user intends to drive to, and the estimated time the user will be departing from the current location. Information such as the current and/or desired charge level may be gathered from the trip manager or from the electric vehicle.

At step 1030, the trip manager may provide a budget that is used to structure if and at what rate charging is to occur. The budget may be defined by the user and may define an amount of money that the user is willing to pay for charging of the electric vehicle. For example, the user may specify that the user is willing to pay 12 cents per kilowatt-hour. If this rate is below what the electric utility operating the ESI is willing to accept, charging may not occur. If the person's budget specifies 18 cents per kilowatt-hour, and the electric company operating ESI is charging 14 cents per kilowatt-hour, charging may occur at the 14 cent rate (or possibly the 18 cent rate indicated by the user's budget). At step 1030, information such as an identifier of the vehicle, the budget, and a deadline may be provided to the ESI. The deadline may specify a time and/or date by which charging of the electric vehicle is to be completed. An identifier of the vehicle may be necessary if the trip manager is executed on a mobile device to allow the trip manager to be associated with the appropriate electric vehicle that has been connected with an EVSE.

At step 1040, communication may occur between the electric vehicle and the ESI. Information exchanged may involve an amount of electricity requested by the electric vehicle. One or more times, at step 1040, a battery status update may be transmitted from the electric vehicle to the ESI. Such communication may occur via the EVSE.

At step 1050, a modified reservation may be received by the electric vehicle from the ESI. This reservation may indicate the charging rate this granted by the ESI to the electric vehicle being charged.

At step 1060, updated information may be received by the trip manager from the ESI. This information may indicate when the charging of the electric vehicle is expected to be completed. The lower the budget provided by the user via the trip manager, the longer it may take for the electric vehicle to be charged. For example, more electricity may be allocated to electric vehicles for charging that are associated with higher budgets. Therefore, the rate of charging for electric vehicles associated with lower budgets may be lower than the rate of charging for electric vehicles associated with higher budgets. Also at step 1060, the trip manager, possibly contingent on input provided by a user, may provide supplemental information, which may include a new budget. For example, a user may desire to provide a new budget to accelerate charging. Due to an increased charging budget, the ESI may accelerate the charging rate or commence charging of the electric vehicle.

At step 1070, an indication that charging of the vehicle's batteries has been completed may be received by the ESI from the electric vehicle via the EVSE. As such, charging of the vehicle via the EVSE may cease. At step 1080, the trip manager may be notified. As such, the trip manager may provide an indication to the user that the charging of the electric vehicle has been completed. An indication of the total cost to charge the electric vehicle may be provided to the user by the trip manager. An account of the person may be debited for the total cost.

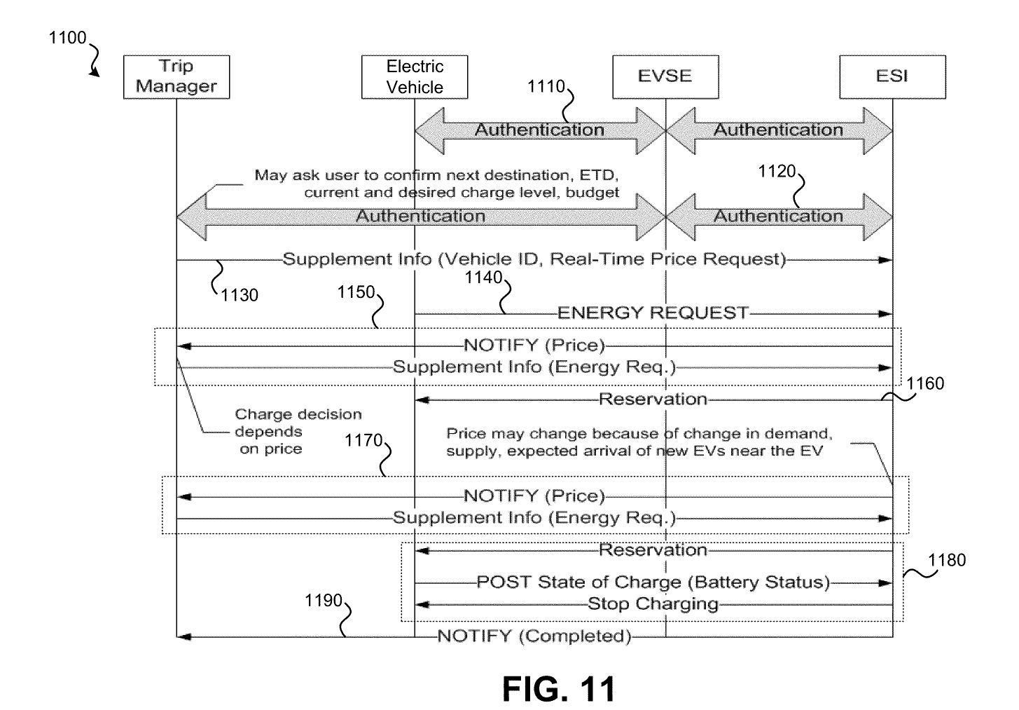

FIG. 11 illustrates a swim diagram of another embodiment of a method 1100 for managing the charging of an electric vehicle. Method 1100 focuses on a charging decision being made using or by the trip manager. Method 1100 involves communication between a trip manager, such as trip manager 210-2 of system 200 of FIG. 2, an electric vehicle, an EVSE (that is used to charge the electric vehicle), and an ESI, such as ESI 150 of FIG. 2.

At step 1110, authentication may occur between the electric vehicle, the EVSE, and the ESI. This may involve the electric vehicle providing a vehicle identifier. The ESI may receive an identifier of the electric vehicle and which EVSE the electric vehicle is connected with. Such authentication may also include starting a meter measurement such that the amount of electricity used to charge the electric vehicle can be accurately measured. At step 1120, authentication and payment information may be communicated between the trip manager, the EVSE, and/or the ESI. Various information may be gathered from the user via the trip manager at step 1120. For example, the user may be prompted to provide an indication of the next destination that the user intends to drive to, the estimated time the user will be departing for the destination, and/or the desired charge level of the vehicle's batteries (e.g., full charge, 75% charge, etc.). Information such as the current and/or desired charge level may alternatively be gathered from the electric vehicle.

At step 1130, information regarding the charging of the vehicle may be transmitted by the trip manager to the ESI. The information transmitted by the trip manager may include an identifier of the vehicle, and/or a (real-time) price request. The price for charging of the electric vehicle may vary based on factors such as: the general demand for electricity, the location, the electrical grid that services the EVSE, and the number of electric vehicles being charged at the same location or in the same geographic region as the electric vehicle.

At step 1140, a request for electricity may be received by the ESI from the electric vehicle via the EVSE. This request may specify the vehicle identifier such that the appropriate trip manager, which may be being executed by a mobile device, may be linked with the electric vehicle. For example, while the electric vehicle may communicate with the ESI via the EVSE, the trip manager may communicate via a different network, such as a cellular wireless network with the ESI. The request of step 1140 may indicate an amount of electricity required by the electric vehicle. It may be possible for the electric vehicle to communicate with the ESI without using the EVSE, such as via a cellular network.

At step 1150, a price may be indicated by the ESI to the trip manager in response to the real time price request at step 1130. Supplemental information, such as the energy required to charge the electric vehicle, may be provided to the trip manager at step 1150. As such, using the amount of energy required by the electric vehicle and the price, an estimate for the total to charge electric vehicle may be provided to the user of the trip manager. Whether charging occurs may be based on the decision made at step 1150 by the trip manager or by the user of the trip manager. For example, a budget may be stored locally by the trip manager that indicates the user's preferences for a price willing to be paid for charging the electric vehicle. Multiple prices may be specified. For example, if the electric vehicle is very low on charge, the user may be willing to pay more than if the electric vehicle still has more than 50% charge. In some embodiments, an estimate (or actual price) for the amount to charge the electric vehicle is provided to the user via the trip manager, at which time the user may be permitted to either accept or reject the price. If accepted, charging may occur; if rejected, charging is not performed. At step 1160, a reservation may be transmitted by the ESI to the electric vehicle. This reservation may indicate the amount of charge and/or the charging rate this granted by the ESI to the electric vehicle being charged.

At step 1170, the price to charge the electric vehicle may change. For example, if the number of electric vehicles within the area of the electric vehicle being charged increases significantly, the price for charging of the electric vehicle may increase during the charging process. Other factors may also affect price, such as a general increase in the demand for electricity in the vicinity of the EVSE, and/or a realized or anticipated increase in the electrical load of the grid servicing the EVSE. Similarly, if demand decreases, the price may decrease. In such a situation, the trip manager may be notified of the price decrease or the price decrease may automatically be applied without notifying the trip manager. The changed price may be transmitted to the trip manager. Based upon the changed price, the trip manager, either automatically or in response to user input, may request continued charging or reject the price, resulting in charging being stopped. It may also be possible for the user to specify that the batteries of electric vehicles are charged only up to a certain charge level (e.g., 70%).

At step 1180, an update on the charging of the battery status may be received by the ESI from the electric vehicle. When the batteries of the electric vehicle are fully charged, or the charge level specified by the trip manager has been reached, charging may cease. At step 1190, the trip manager may be notified that the charging is completed. The trip manager may also be notified of a final amount of electricity used to charge the vehicle and/or the total price for charging the vehicle. An account of the user may be debited for the appropriate amount.

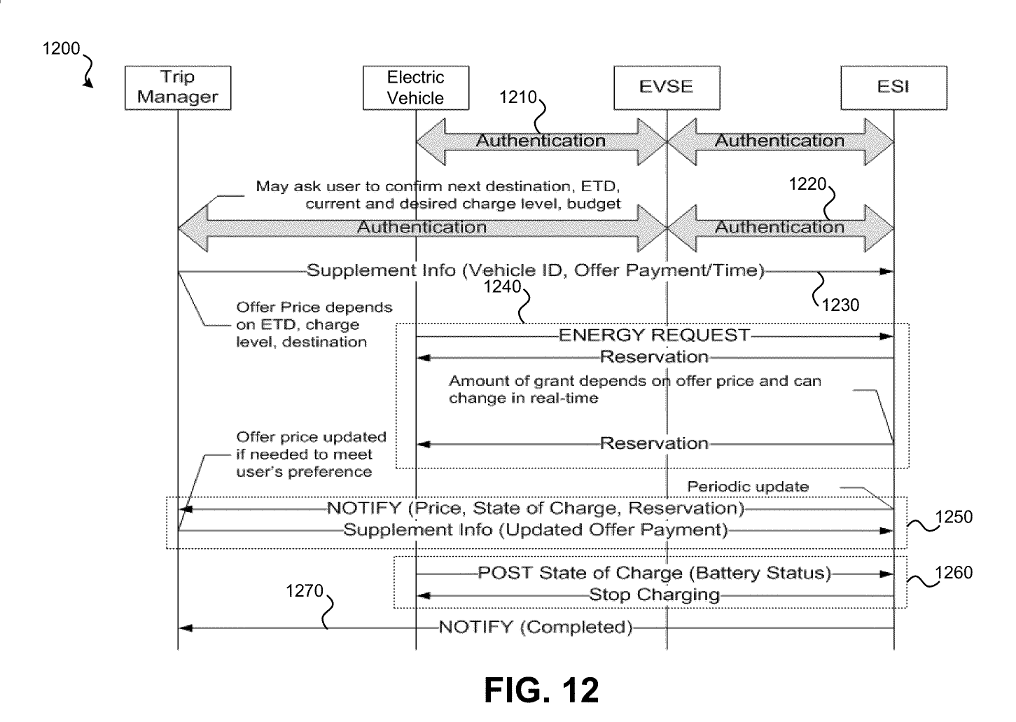

FIG. 12 illustrates a swim diagram of another embodiment of a method for managing the charging of an electric vehicle. Method 1200 focuses on auction-based charging of electric vehicles. Method 1200 involves communication between a trip manager, such as trip manager 210-2 of system 200 of FIG. 2, an electric vehicle, an EVSE (that is used to charge the electric vehicle), and an ESI, such as ESI 150 of FIG. 2.

At step 1210, authentication may occur between the electric vehicle, the EVSE, and the ESI. This may involve the electric vehicle providing a vehicle identifier. The ESI may receive an indication such that it knows the identifier of the electric vehicle and which EVSE the electric vehicle is connected with. Such authentication may also include starting a meter measurement such that the amount of electricity used to charge the electric vehicle can be accurately measured. At step 1220, authentication and payment may occur between the trip manager, the EVSE, and the ESI. Various information may be gathered from the user via the trip manager at step 1220. For example, the user may be prompted to provide an indication of the next destination that the user intends to drive to, and the estimated time the user will be departing for the destination. Information such as the current and/or desired charge level may be gathered from the trip manager or from the electric vehicle.

At step 1230, various information may be provided by the trip manager to the ESI. This information may be determined by the trip manager or may be based on user input provided to the trip manager. The trip manager may provide an identifier of the vehicle and may provide an offer for electricity to charge the electric vehicle. The user may specify an amount willing to be paid and the time by which charging must occur.

At step 1240, the electric vehicle may communicate with the ESI via the EVSE to request a particular amount of electricity needed to charge the batteries of the electric vehicle.

Also, a current state of charge of the battery and/or a charging rate that is acceptable to the battery of the electric vehicle may be sent to the ESI.

At step 1250, the ESI may transmit a message to the trip manager that indicates the current charge level of the electric vehicle and the price to charge the electric vehicle. The price may be based on the offer of payment and the amount of time needed to charge the vehicle received at step 1230. For example, if the payment offer at step 1230 was less than the offers associated with other vehicles in the vicinity of the EVSE, the offer received from the trip manager may be rejected by the ESI with a counteroffer being specified by the price at step 1250. The price specified by the ESI at step 1250 may be presented to the user, along with the charge state of the electric vehicle. The price specified by the ESI at step 1250 may reflect the offer made by the trip manager at step 1230; however, the rate at which the charging occurs at that price may be selected by the ESI. As such, if the offer of step 1230 was insufficient, the ESI may indicate that charging will take longer than an amount of time specified at step 1230. In response to the price received at step 1250, the trip manager may automatically, or in response from input provided by the user, provide an updated payment offer to the ESI. Such an updated offer may result in the amount of time required to charge the electric vehicle being decreased.

At step 1260, an indication of the current charge level from the electric vehicle may be received by the ESI. For example, this charge level may indicate that the batteries have been fully charged. In response to the batteries being charged to the appropriate level, charging by the EVSE may be stopped by the ESI. At step 1270, the ESI may notify the trip manager that charging has been completed. A final price may also be transmitted to the trip manager. An account of the user may be debited for the cost of the charging of the electric vehicle.

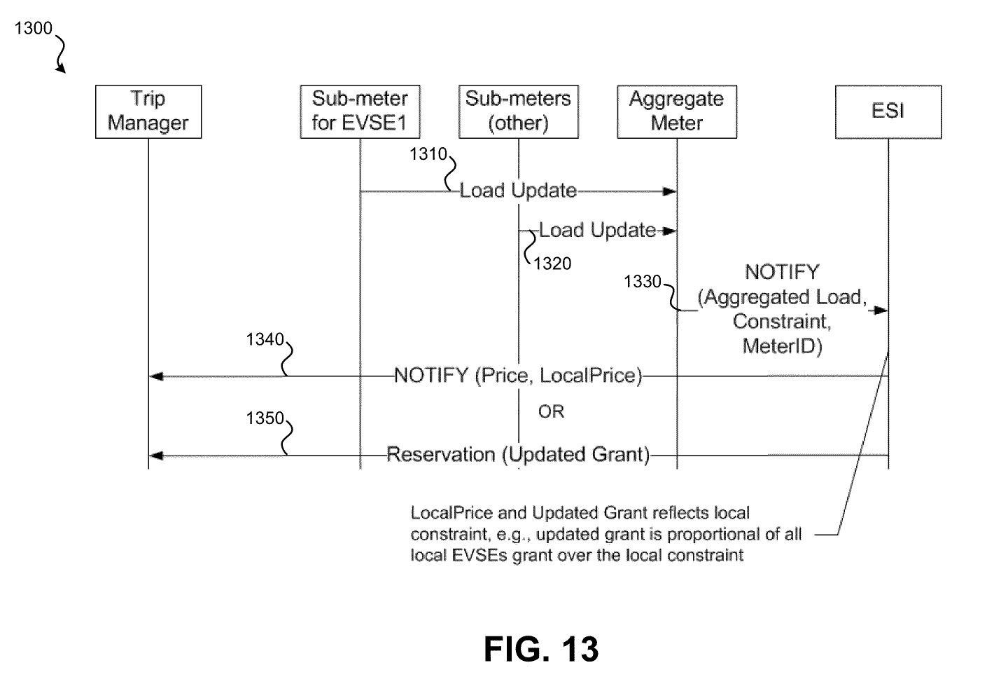

FIG. 13 illustrates a swim diagram of an embodiment of a method 1300 for managing the charging of an electric vehicle in accordance with one or more local constraints. In addition to charging vehicles based on supply and demand factors, other constraints may be considered. For example, a particular location (which may have multiple EVSEs) may only be able to handle a maximum electrical load. As such, the total rate of charging performed using EVSEs may be limited. In some embodiments the local constraint may be a surcharge for using the EVSE to charge the vehicle's batteries. Method 1300 illustrates how such a constraint may be factored in with the charging of electric vehicles.

At step 1310, a meter for a particular EVSE, indicated here as EVSE1, may provide an electrical load update to an aggregate meter. This load update may indicate the amount of electricity being consumed for charging of the electric vehicle by EVSE1. One or more additional meters for other EVSEs may provide a similar indication to the aggregate meter at step 1320. At step 1330, the aggregate meter may notify the ESI of the aggregated electrical load, a constraint that limits the aggregated load, and an identifier of the aggregate meter. For example, the aggregate meter may measure the amount of electricity being consumed by all of the EVSEs in a building and a maximum of 30 kWh may be permitted to be consumed by all of these EVSEs. The ESI may be notified of the aggregated load, the 30 kWh limit, and an identifier of the aggregate meter. The ESI may also be notified of a surcharge to be applied for use of an EVSE.

At step 1340, the ESI may notify the trip manager of a price which may be modified to reflect the local surcharge due to the limitation of the aggregate meter and/or for use of the EVSE. As the load constraint of the aggregate meter is approached, the cost for charging, using the EVSE connected with the aggregate meter, may increase in an attempt to decrease demand. At step 1350, an updated grant may be provided to the trip manager that adjusts the amount of electricity provided to one or more EVSEs.

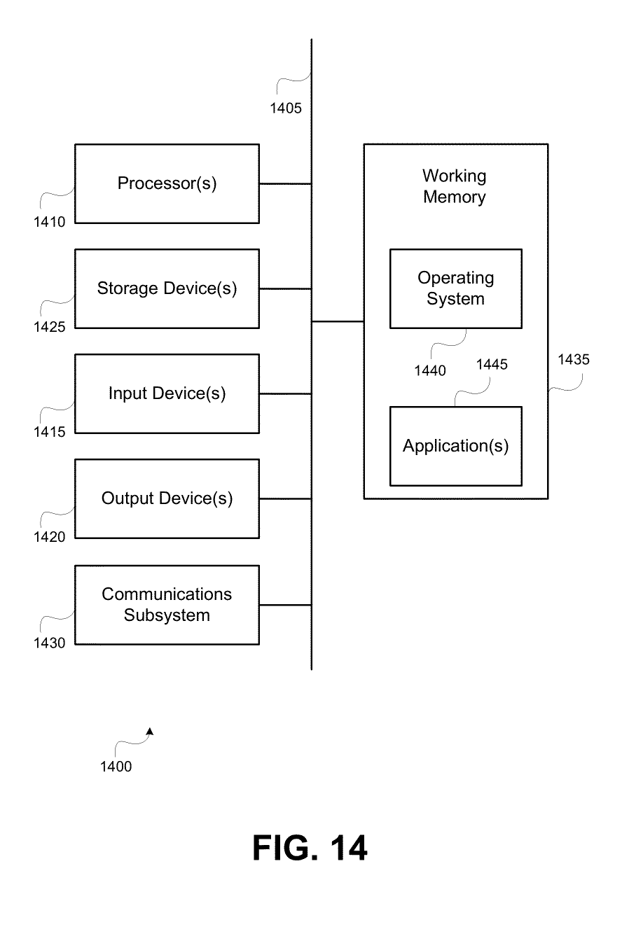

FIG. 14 illustrates an embodiment of a computer system. A computer system as illustrated in FIG. 14 may be incorporated as part of the previously described computerized devices. For example, computer system 1400 can represent some of the components of the mobile devices, vehicles, location managers (e.g., home servers), ESIs, EVSEs, host computer system, other data sources, etc. It should be noted that FIG. 14 is meant only to provide a generalized illustration of various components, any or all of which may be utilized as appropriate. FIG. 14, therefore, broadly illustrates how individual system elements may be implemented in a relatively separated or relatively more integrated manner.

The computer system 1400 is shown comprising hardware elements that can be electrically coupled via a bus 1405 (or may otherwise be in communication, as appropriate). The hardware elements may include one or more processors 1410, including without limitation one or more general-purpose processors and/or one or more special-purpose processors (such as digital signal processing chips, graphics acceleration processors, and/or the like); one or more input devices 1415, which can include without limitation a mouse, a keyboard, and/or the like; and one or more output devices 1420, which can include without limitation a display device, a printer, and/or the like.

The computer system 1400 may further include (and/or be in communication with) one or more non-transitory storage devices 1425, which can comprise, without limitation, local and/or network accessible storage, and/or can include, without limitation, a disk drive, a drive array, an optical storage device, a solid-state storage device, such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The computer system 1400 might also include a communications subsystem 1430, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 1430 may permit data to be exchanged with a network (such as the network described below, to name one example), other computer systems, and/or any other devices described herein. In many embodiments, the computer system 1400 will further comprise a working memory 1435, which can include a RAM or ROM device, as described above.

The computer system 1400 also can comprise software elements, shown as being currently located within the working memory 1435, including an operating system 1440, device drivers, executable libraries, and/or other code, such as one or more application programs 1445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1425 described above. In some cases, the storage medium might be incorporated within a computer system, such as computer system 1400. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 1400 and/or might take the form of source and/or installable code, which, upon compilation and/or installation on the computer system 1400 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices, such as network input/output devices, may be employed.

As mentioned above, in one aspect, some embodiments may employ a computer system (such as the computer system 1400) to perform methods in accordance with various embodiments of the invention. According to a set of embodiments, some or all of the procedures of such methods are performed by the computer system 1400 in response to processor 1410 executing one or more sequences of one or more instructions (which might be incorporated into the operating system 1440 and/or other code, such as an application program 1445) contained in the working memory 1435. Such instructions may be read into the working memory 1435 from another computer-readable medium, such as one or more of the storage device(s) 1425. Merely by way of example, execution of the sequences of instructions contained in the working memory 1435 might cause the processor(s) 1410 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 1400, various computer-readable media might be involved in providing instructions/code to processor(s) 1410 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 1425. Volatile media include, without limitation, dynamic memory, such as the working memory 1435.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 1410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1400.

The communications subsystem 1430 (and/or components thereof) generally will receive signals, and the bus 1405 then might carry the signals (and/or the data, instructions, etc. carried by the signals) to the working memory 1435, from which the processor(s) 1410 retrieves and executes the instructions. The instructions received by the working memory 1435 may optionally be stored on a non-transitory storage device 1425 either before or after execution by the processor(s) 1410.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

What is claimed is:

1. A method for anticipating an electrical load, the method comprising:
receiving, by a computer system, a plurality of indications of locations of a vehicle;
identifying, by the computer system, a travel pattern of the vehicle based on the plurality of indications of locations of the vehicle, wherein the travel pattern indicates:
a destination; and
an expected travel time to arrive at the destination;
receiving, by the computer system, a current location of the vehicle; and
identifying, by the computer system, an anticipated electrical load at the destination at least partially based on the travel pattern.

2. The method for anticipating the electrical load of claim 1, the method further comprising:
identifying, by the computer system, a decrease in an anticipated electrical load at the current location of the vehicle at least partially based on the vehicle departing from the current location.

3. The method for anticipating the electrical load of claim 1, the method further comprising:
at least partially based on the current location of the vehicle, determining, by the computer system, that the vehicle is expected to conform to the travel pattern.

4. The method for anticipating the electrical load of claim 1, the method further comprising:
modifying, by the computer system, electrical usage at least partially based on an anticipated arrival of the vehicle at the destination.

5. The method for anticipating the electrical load of claim 4, wherein modifying electrical usage at least partially based on the anticipated arrival of the vehicle at the destination is further at least partially based on the expected travel time to arrive at the destination indicated by the travel pattern.

6. The method for anticipating the electrical load of claim 4, wherein:
the vehicle is a chargeable electric vehicle; and
modifying electrical usage at least partially based on the anticipated arrival of the vehicle at the destination comprises:
allocating sufficient electrical capacity to at least partially charge the chargeable electric vehicle.

7. The method for anticipating the electrical load of claim 6, further comprising:
determining an identity of a person associated with the travel pattern, wherein modifying electrical usage at least partially based on the anticipated arrival of the vehicle at the destination is at least partially based on the identity of the person.

8. The method for anticipating the electrical load of claim 4, wherein modifying electrical usage at least partially based on the anticipated arrival of the vehicle at the destination comprises activating an electrical device before the anticipated arrival of the vehicle at the destination.

9. The method for anticipating the electrical load of claim 4, wherein modifying electrical usage at least partially based on the anticipated arrival of the vehicle at the destination comprises modifying a charging schedule of a second vehicle.

10. The method for anticipating the electrical load of claim 9, wherein the charging schedule comprises a rate of charging.

11. The method for anticipating the electrical load of claim 9, wherein charging of the second vehicle occurs at a location different from the destination.

12. The method for anticipating the electrical load of claim 1, further comprising:
determining a plurality of locations comprising a current location of a mobile device associated with the vehicle, wherein:
the plurality of indications of locations are the plurality of locations of the mobile device associated with the vehicle, and
the current location of the vehicle is the current location of the mobile device.

13. The method for anticipating the electrical load of claim 4, wherein modifying electrical usage at least partially based on the anticipated arrival of the vehicle at the destination comprises indicating that a power-generation source is to be activated.

14. A method for scheduling charging of an electric vehicle, the method comprising:
identifying, by a computer system, a charging budget;
receiving, by the computer system, a pricing rate for electricity;
using the charging budget, determining, by the computer system, to charge the electric vehicle at the pricing rate; and
transmitting, by the computer system, an indication to charge the electric vehicle to a remote computer system.

15. The method for scheduling charging of the electric vehicle of claim 14, the method comprising:
identifying, by the computer system, a current level of charge of the electric vehicle;
identifying, by the computer system, an anticipated destination;
identifying, by the computer system, an anticipated time of departure; and
determining, by the computer system, the charging budget using the anticipated destination, the current level of charge of the electric vehicle, and the anticipated destination.

16. The method for scheduling charging of the electric vehicle of claim 14, further comprising:
receiving, by the computer system, a budget parameter from a user of the electric vehicle, wherein the charging budget is created using the budget parameter.

17. A system for anticipating an electrical load, the system comprising:
a processor; and
a memory communicatively coupled with and readable by the processor and having stored therein processor-readable instructions which, when executed by the processor, cause the processor to:
receive a plurality of indications of locations of a vehicle;
identify a travel pattern of the vehicle based on the plurality of indications of locations of the vehicle, wherein the travel pattern indicates:
a destination; and
an expected travel time to arrive at the destination;
receive a current location of the vehicle; and
identify an anticipated electrical load at the destination at least partially based on the travel pattern.

18. The system for anticipating the electrical load of claim 17, wherein the processor-readable instructions further comprise processor-readable instructions, which, when executed by the processor, cause the processor to:
identify a decrease in an anticipated electrical load at the current location of the vehicle at least partially based on the vehicle departing from the current location.

19. The system for anticipating the electrical load of claim 17, wherein the processor-readable instructions further comprise processor-readable instructions, which, when executed by the processor, cause the processor to:
at least partially based on the current location of the vehicle, determine that the vehicle is expected to conform to the travel pattern.

20. The system for anticipating the electrical load of claim 17, wherein the processor-readable instructions further comprise processor-readable instructions, which, when executed by the processor, cause the processor to:
cause electrical usage to be modified at least partially based on an anticipated arrival of the vehicle at the destination.

21. The system for anticipating the electrical load of claim 20, wherein the processor-readable instructions, which, when executed by the processor cause the processor to cause electrical usage to be modified at least partially based on the anticipated arrival of the vehicle at the destination is further at least partially based on the expected travel time to arrive at the destination indicated by the travel pattern.

22. The system for anticipating the electrical load of claim 20, wherein:
the vehicle is a chargeable electric vehicle; and
the processor-readable instructions, which, when executed by the processor cause the processor to cause electrical usage to be modified at least partially based on the anticipated arrival of the vehicle at the destination comprises processor-readable instructions, which, when executed by the processor, cause the processor to:
allocate sufficient electrical capacity to at least partially charge the chargeable electric vehicle.

23. The system for anticipating the electrical load of claim 22, wherein the processor-readable instructions further comprise processor-readable instructions, which, when executed by the processor, cause the processor to:
determine an identity of a person associated with the travel pattern, wherein the processor-readable instructions, which, when executed by the processor, cause the processor to cause electrical usage to be modified at least partially based on the anticipated arrival of the vehicle at the destination is at least partially based on the identity of the person.

24. The system for anticipating the electrical load of claim 20, wherein the processor-readable instructions, which, when executed by the processor, cause the processor to cause electrical usage to be modified at least partially based on the anticipated arrival of the vehicle at the destination comprises processor-readable instructions, which, when executed by the processor, cause the processor to cause an electrical device to be activated before the anticipated arrival of the vehicle at the destination.

25. The system for anticipating the electrical load of claim 20, wherein the processor-readable instructions, which, when executed by the processor, cause the processor to cause electrical usage to be modified at least partially based on the anticipated arrival of the vehicle at the destination comprises processor-readable instructions, which, when executed by the processor, cause the processor to modify a charging schedule of a second vehicle.

26. The system for anticipating the electrical load of claim 25, wherein the charging schedule comprises a rate of charging.

27. The system for anticipating the electrical load of claim 25, wherein charging of the second vehicle occurs at a location different from the destination.

28. The system for anticipating the electrical load of claim 17, wherein:
the plurality of indications of locations are determined by a mobile device; and
the current location of the vehicle is based on the mobile device's location.

29. The system for anticipating the electrical load of claim 20, wherein the processor-readable instructions, which, when executed by the processor, cause the processor to cause electrical usage to be modified at least partially based on the anticipated arrival of the vehicle at the destination comprises processor-readable instructions, which, when executed by the processor, cause the processor to indicate that a power-generation source is to be activated.

30. A system for scheduling charging an electric vehicle, the system comprising:
a processor; and
a memory communicatively coupled with and readable by the processor and having stored therein processor-readable instructions which, when executed by the processor, cause the processor to:
identify a charging budget;
receive a pricing rate for electricity;
using the charging budget, determine to charge the electric vehicle at the pricing rate; and
cause an indication to charge the electric vehicle to be transmitted to a remote computer system.

31. The system for scheduling charging of the electric vehicle of claim 30, wherein the processor-readable instructions further comprise processor-readable instructions, which, when executed by the processor, cause the processor to:
identify a current level of charge of the electric vehicle;
identify an anticipated destination;
identify an anticipated time of departure; and
determine the charging budget using the anticipated destination, the current level of charge of the electric vehicle, and the anticipated destination.

32. The system for scheduling charging of the electric vehicle of claim 30, wherein the processor-readable instructions further comprise processor-readable instructions, which, when executed by the processor, cause the processor to receive a budget parameter from a user of the electric vehicle, wherein the charging budget is created using the budget parameter.

33. A computer program product residing on a non-transitory processor-readable medium for anticipating an electrical load, the computer program product comprising processor-readable instructions configured to cause a processor to:
receive a plurality of indications of locations of a vehicle;
identify a travel pattern of the vehicle based on the plurality of indications of locations of the vehicle, wherein the travel pattern indicates:
a destination; and
an expected travel time to arrive at the destination;
receive a current location of the vehicle; and
identify an anticipated electrical load at the destination at least partially based on the travel pattern.

34. The computer program product for anticipating the electrical load of claim 33, wherein the processor-readable instructions further comprise processor-readable instructions, which, when executed by the processor, cause the processor to:
identify a decrease in an anticipated electrical load at the current location of the vehicle at least partially based on the vehicle departing from the current location.

35. The computer program product for anticipating the electrical load of claim 33, wherein the processor-readable instructions further comprise processor-readable instructions, which, when executed by the processor, cause the processor to:
at least partially based on the current location of the vehicle, determine that the vehicle is expected to conform to the travel pattern.

36. The computer program product for anticipating the electrical load of claim 33, wherein the processor-readable instructions further comprise processor-readable instructions, which, when executed by the processor, cause the processor to:
cause electrical usage to be modified at least partially based on an anticipated arrival of the vehicle at the destination.

37. The computer program product for anticipating the electrical load of claim 36, wherein the processor-readable instructions, which, when executed by the processor cause the processor to cause electrical usage to be modified at least partially based on the anticipated arrival of the vehicle at the destination is further at least partially based on the expected travel time to arrive at the destination indicated by the travel pattern.

38. The computer program product for anticipating the electrical load of claim 36, wherein the processor-readable instructions, which, when executed by the processor, cause the processor to cause electrical usage to be modified at least partially based on the anticipated arrival of the vehicle at the destination comprises processor-readable instructions, which, when executed by the processor, cause the processor to cause an electrical device to be activated before the anticipated arrival of the vehicle at the destination.

39. The computer program product for anticipating the electrical load of claim 36, wherein:
the vehicle is a chargeable electric vehicle; and
the processor-readable instructions, which, when executed by the processor cause the processor to cause electrical usage to be modified at least partially based on the anticipated arrival of the vehicle at the destination comprises processor-readable instructions, which, when executed by the processor, cause the processor to:
allocate sufficient electrical capacity to at least partially charge the chargeable electric vehicle.

40. The computer program product for anticipating the electrical load of claim 36, wherein the processor-readable instructions further comprise processor-readable instructions, which, when executed by the processor, cause the processor to:
determine an identity of a person associated with the travel pattern, wherein the processor-readable instructions, which, when executed by the processor, cause the processor to cause electrical usage to be modified at least partially based on the anticipated arrival of the vehicle at the destination is at least partially based on the identity of the person.

41. The computer program product for anticipating the electrical load of claim 36, wherein the processor-readable instructions, which, when executed by the processor, cause the processor to cause electrical usage to be modified at least partially based on the anticipated arrival of the vehicle at the destination comprises processor-readable instructions, which, when executed by the processor, cause the processor to modify a charging schedule of a second vehicle.

42. The computer program product for anticipating the electrical load of claim 41, wherein charging of the second vehicle occurs at a location different from the destination.

43. The computer program product for anticipating the electrical load of claim 33, wherein:
the plurality of indications of locations are determined by a mobile device; and
the current location of the vehicle is based on the mobile device's location.

44. The computer program product for anticipating the electrical load of claim 36, wherein the processor-readable instructions, which, when executed by the processor, cause the processor to cause electrical usage to be modified at least partially based on the anticipated arrival of the vehicle at the destination comprises processor-readable instructions, which, when executed by the processor, cause the processor to indicate that a power-generation source is to be activated.

45. A computer program product residing on a non-transitory processor-readable medium for scheduling charging of an electric vehicle, the computer program product comprising processor-readable instructions configured to cause a processor to:
identify a charging budget;
receive a pricing rate for electricity;
using the charging budget, determine to charge the electric vehicle at the pricing rate; and
cause an indication to charge the electric vehicle to be transmitted to a remote computer system.

46. The computer program product for scheduling charging of the electric vehicle of claim 45, wherein the processor-readable instructions further comprise processor-readable instructions, which, when executed by the processor, cause the processor to:
identify a current level of charge of the electric vehicle;
identify an anticipated destination;
identify an anticipated time of departure; and
determine the charging budget using the anticipated destination, the current level of charge of the electric vehicle, and the anticipated destination.

47. The computer program product for scheduling charging of the electric vehicle of claim 45, wherein the processor-readable instructions further comprise processor-readable instructions, which, when executed by the processor, cause the processor to receive a budget parameter from a user of the electric vehicle, wherein the charging budget is created using the budget parameter.

48. An apparatus for anticipating an electrical load, the apparatus comprising:
means for receiving a plurality of indications of locations of a vehicle;
means for identifying a travel pattern of the vehicle based on the plurality of indications of locations of the vehicle, wherein the travel pattern indicates:
a destination; and
an expected travel time to arrive at the destination;
means for receiving a current location of the vehicle; and
means for identifying an anticipated electrical load at the destination at least partially based on the travel pattern.

49. The apparatus for anticipating the electrical load of claim 48, the apparatus further comprising:
means to identify a decrease in an anticipated electrical load at the current location of the vehicle at least partially based on the vehicle departing from the current location.

50. The apparatus for anticipating the electrical load of claim 48, the apparatus further comprising:
means for determining that the vehicle is expected to conform to the travel pattern at least partially based on the current location of the vehicle.

51. The apparatus for anticipating the electrical load of claim 48, the apparatus further comprising:
means for modifying electrical usage at least partially based on an anticipated arrival of the vehicle at the destination.

52. The apparatus for anticipating the electrical load of claim 51, wherein the means for modifying electrical usage at least partially based on the anticipated arrival of the vehicle at the destination is further at least partially based on the expected travel time to arrive at the destination indicated by the travel pattern.

53. The apparatus for anticipating the electrical load of claim 51, wherein:
the vehicle is a chargeable electric vehicle; and
the means for modifying electrical usage at least partially based on the anticipated arrival of the vehicle at the destination comprises:
means for allocating sufficient electrical capacity to at least partially charge the chargeable electric vehicle.

54. The apparatus for anticipating the electrical load of claim 51, wherein the means for modifying electrical usage at least partially based on the anticipated arrival of the vehicle at the destination comprises means for activating an electrical device before the anticipated arrival of the vehicle at the destination.

55. The apparatus for anticipating the electrical load of claim 51, further comprising:
means for determining an identity of a person associated with the travel pattern, wherein modifying electrical usage at least partially based on the anticipated arrival of the vehicle at the destination is at least partially based on the identity of the person.

56. The apparatus for anticipating the electrical load of claim 54, wherein the means for modifying electrical usage at least partially based on the anticipated arrival of the vehicle at the destination comprises means for modifying a charging schedule of a second vehicle.

57. The apparatus for anticipating the electrical load of claim 56, wherein the charging schedule comprises a rate of charging.

58. The apparatus for anticipating the electrical load of claim 56, wherein charging of the second vehicle occurs at a location different from the destination.

59. The apparatus for anticipating the electrical load of claim 48, wherein:
the plurality of indications of locations are determined by a mobile device; and
the current location of the vehicle is based on the mobile device's location.

60. The apparatus for anticipating the electrical load of claim 51, wherein the means for modifying electrical usage at least partially based on the anticipated arrival of the vehicle at the destination comprises means for indicating that a power-generation source is to be activated.

61. An apparatus for scheduling charging of an electric vehicle, the apparatus comprising:
means for identifying a charging budget;
means for receiving a pricing rate for electricity;
means for determining to charge the electric vehicle at the pricing rate using the charging budget; and
means for transmitting an indication to charge the electric vehicle to a remote computer system.

62. The apparatus for scheduling charging of the electric vehicle of claim 61, the apparatus further comprising:
means for identifying a current level of charge of the electric vehicle;
means for identifying an anticipated destination;
means for identifying an anticipated time of departure; and
means for determining the charging budget using the anticipated destination, the current level of charge of the electric vehicle, and the anticipated destination.

63. The apparatus for scheduling charging of the electric vehicle of claim 61, further comprising:
means for receiving a budget parameter from a user of the electric vehicle, wherein the charging budget is created using the budget parameter.

64. A method for anticipating a decrease in an electrical load, the method comprising:
receiving, by a computer system, a current location of a vehicle;
determining, by the computer system, the vehicle is departing from the current location;
identifying, by the computer system, an anticipated decrease in the electrical load at least partially based on the vehicle departing from the current location.
